(19) United States
(12) Patent Application Publication
(10) Pub. No.: US 2020/0014783 A1
(43) Pub. Date: Jan. 9, 2020

(54) Global Dialing Format

(71) Applicant: Victor Tokunbo Ojesina, Houston, TX (US)

(72) Inventor: Victor Tokunbo Ojesina, Houston, TX (US)

(21) Appl. No.: 16/504,402

(22) Filed: Jul. 8, 2019

Related U.S. Application Data
(60) Provisional application No. 62/695,203, filed on Jul. 9, 2018.

(51) Int. Cl. H04M 1/2745; H04M 1/725; H04M 15/00

(52) U.S. Cl. CPC H04M 1/274566; H04M 15/755; H04M 1/72572

(57) ABSTRACT

A method for using a global dialing format is described. The method comprises displaying a sequence of digits to be dialed from a communication device. The method also comprises determining a current country for the communication device and a destination country for the sequence of digits. The method further comprises accessing a database to obtain an exit code for the current country and a standardized country code for the destination country. The standardized country code corresponds to an entry code for the destination country. The method additionally comprises converting the sequence of digits to a phone number in the global dialing format. The phone number comprises the exit code for the current country, the standardized country code for the destination country, and the sequence of digits. The method also includes dialing the phone number.

### TECHNICAL FIELD

The present disclosure relates generally to a global dialing format for placing domestic and international phone calls. More specifically, the present techniques relate to converting a phone number to the global dialing format.

### BACKGROUND ART

There are multiple standards and conventions that govern how a phone number may be formatted. A user of a mobile device must be familiar with these standards and conventions to successfully place domestic and international phone calls.

### BRIEF DESCRIPTION OF THE DRAWINGS

FIG. 1 is a process flow diagram of a method for installing a software application that converts a phone number to the Toks ISO-Numeric (TIN) dialing format and then dials the reformatted phone number.

FIGS. 2A and 2B are a detailed process flow diagram of a method for launching an installed software application that converts a phone number to the TIN dialing format and then dials the reformatted phone number.

FIGS. 3A and 3AA are a detailed process flow diagram of a method for reformatting domestic and international phone numbers.

FIGS. 3B and 3BB are a detailed process flow diagram of a method for converting phone numbers starting with a “+” symbol to the TIN format.

FIGS. 3C and 3CC are a detailed process flow diagram of a method for converting a phone number starting with an exit code for a user's home country to the TIN format.

FIGS. 3D and 3DD are a detailed process flow diagram of a method for converting a phone number containing any combination of an exit code and an entry code to the TIN format.

FIG. 3E is a process flow diagram of a method for converting domestic phone numbers to the TIN format.

FIG. 3F is a process flow diagram of a method for converting ambiguous phone numbers to the TIN format.

FIG. 4A is an illustration of a country selector screen of a mobile application used during the manual intervention process.

FIG. 4B is an illustration of a screen of a mobile application displaying unresolved phone numbers.

FIG. 5 is an illustration of a home screen of a mobile application.

FIG. 6A is an illustration of a screen of a mobile application showing a contacts list prior to sorting.

FIG. 6B is an illustration of a screen of a mobile application showing a call log listing phone numbers saved in the TIN format.

FIG. 7A is an illustration of a screen of a mobile application showing global calling methods.

FIG. 7B is an illustration of a screen of a mobile application showing an alert related to a calling method.

FIG. 8A is an illustration of a screen of a mobile application showing a global dialer interface.

FIG. 8B is an illustration of a screen of a mobile application showing a call log interface.

FIG. 8C is another illustration of a screen of a mobile application showing a global dialer interface.

FIG. 8D is an illustration of a screen of a mobile application showing a contacts list interface when an international phone call is made.

FIG. 8E is an illustration of a screen of a mobile application showing a dialer interface when an international phone call is made.

FIG. 9A is a process flow diagram of a method for dialing a phone number in the TIN format.

FIGS. 9B and 9BB are a process flow diagram of a method for placing domestic phone calls.

FIG. 9C is a process flow diagram of a method for verifying phone numbers.

FIGS. 9D and 9DD are a process flow diagram of a method for placing international phone calls.

FIG. 9E is a process flow diagram of a method for placing phone calls within an international telecommunication alliance.

FIG. 10A is an illustration of a screen of a mobile application for placing international phone calls.

FIG. 10B is an illustration of a screen of a mobile application for placing an international phone call to a land line.

FIG. 10C is an illustration of a screen of a mobile application for placing an international phone call to a mobile device.

FIG. 11 is a section from a verification database.

FIGS. 12A and 12B are a section from a dialing codes database.

FIG. 13 is a section from a database containing countries with multiple carrier exit codes.

### DESCRIPTION OF THE EMBODIMENTS

A phone number must be dialed in a certain format if the phone call is to reach the intended recipient. However, this format is not necessarily the format in which the phone number is saved on a mobile device.

A phone number must contain certain codes depending upon the originating and destination countries. For example, a trunk code is required in most countries when placing domestic phone calls. An exit code to exit the originating county and an entry code to enter the destination country are required when placing international calls. If any of these codes is not saved, a mobile device cannot dial the phone number without manual intervention. A user has to add the missing code(s) before the phone number can be dialed. This requires the user to be familiar with trunk codes, exit codes, and entry codes for multiple countries.

When a global dialing format is used, a mobile device saves a phone number in a format that is uniform across countries. A method associated with the global dialing format generates trunk codes and country codes which are concatenated with the phone number when it is dialed. The global dialing format obviates the need for the user to intervene and add missing codes when dialing a phone number.

The subject matter disclosed herein relates to a format that results in uniformity when phone numbers are dialed or saved. The present disclosure describes techniques for using a global dialing format. For example, a sequence of digits to be dialed from a communication device may be displayed. A current country for the communication device and a destination country for the sequence of digits may be determined. A database may be accessed to obtain an exit code for the current country and a standardized country code for the destination country. The standardized country code may correspond to an entry code for the destination country. The sequence of digits may be converted to a phone number in the global dialing format. The phone number may contain the exit code for the current country, the standardized country code for the destination country, and the sequence of digits. The phone number may be dialed. Various examples of the present techniques are described in detail below. Reference is made to the figures.

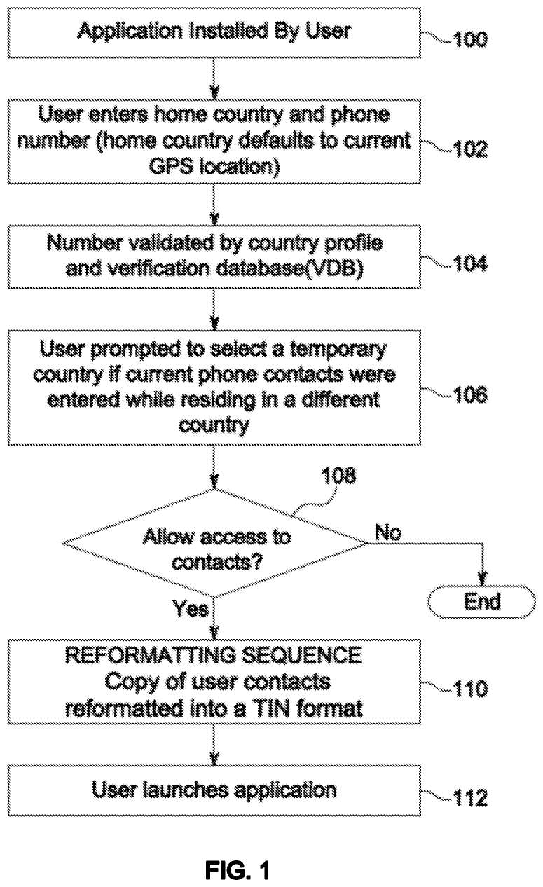

FIG. 1 is a process flow diagram of a method for installing a software application that converts a phone number to the Toks ISO-Numeric (TIN) dialing format and then dials the reformatted phone number. TIN refers to the concatenation of the International Organization for Standardization (ISO) code for the country to be called and the local phone number (i.e., the phone number in the country represented by the ISO code). ISO code refers to the unique three-letter code for a country. For example, a phone number in the United States would be USA.1234567890 in the TIN format. The process begins at block 100.

At block 100, an application may be installed on a mobile device by a user. The term “mobile device” includes smart phones, laptops, tablets (e.g., iPods and iPads), and any other transportable electronic devices having sufficient computing capability to implement the embodiments described in the present disclosure. Further, installation of the application need not be limited to mobile devices. For example, a desktop computer may be used to implement the embodiments described herein. The process continues at block 102.

At block 102, the user may be prompted to enter his or her current location and phone number. Alternatively, the user's current location may be determined by GPS. The process continues at block 104.

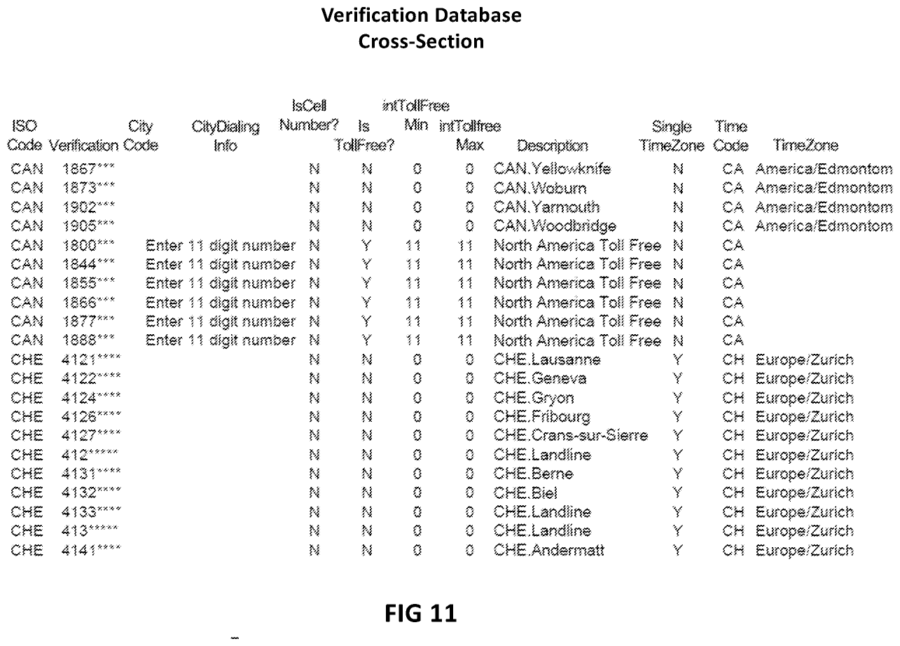

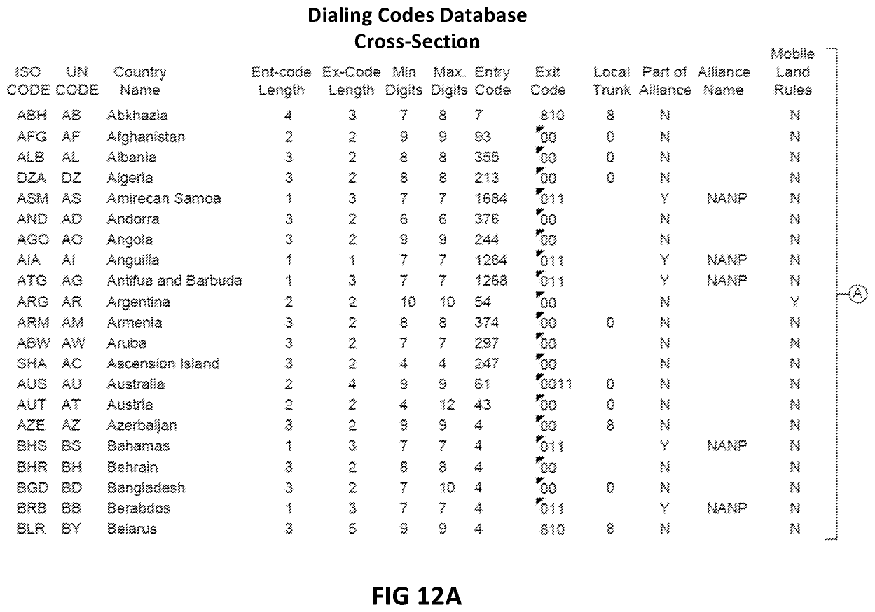

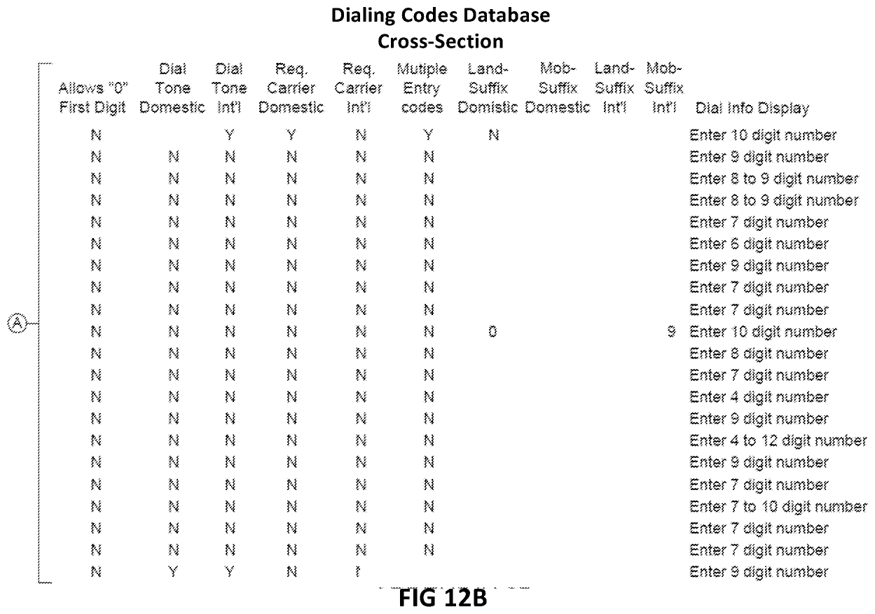

At block 104, the phone number to be reformatted may be validated using the verification database shown in FIG. 11 and the dialing codes database shown in FIGS. 12A and 12B. In FIG. 11, the first column contains the ISO code for various countries. The second column contains a verification sequence. The verification sequence is at most the first six digits of the phone numbers specific to the country whose ISO code is given in the first column. The first few digits of the phone number are compared to the verification sequence for the destination country.

The phone number is validated if the first few digits of the phone number match the verification sequence. The phone number to be reformatted may be further validated using the dialing codes database in FIGS. 12A and 12B. The dialing codes database lists the minimum and maximum rules (MMR) for the country whose ISO code is given in the first column. The MMR specify the minimum and maximum number of digits a phone number may contain. The phone number is further validated if it satisfies the MMR for the destination country. The process continues at block 106.

At block 106, the user may be prompted to select the country he or she is visiting (the temporary country) if the contacts list on the user's phone was entered while the user was located in another country. If the user does not select a country when prompted, the location defaults to the country the user is visiting. The process continues with the query at block 108.

At block 108, it is determined whether the application may access the contacts list on the user's phone. If access is allowed, the process continues at block 110. The process ends if access is not allowed.

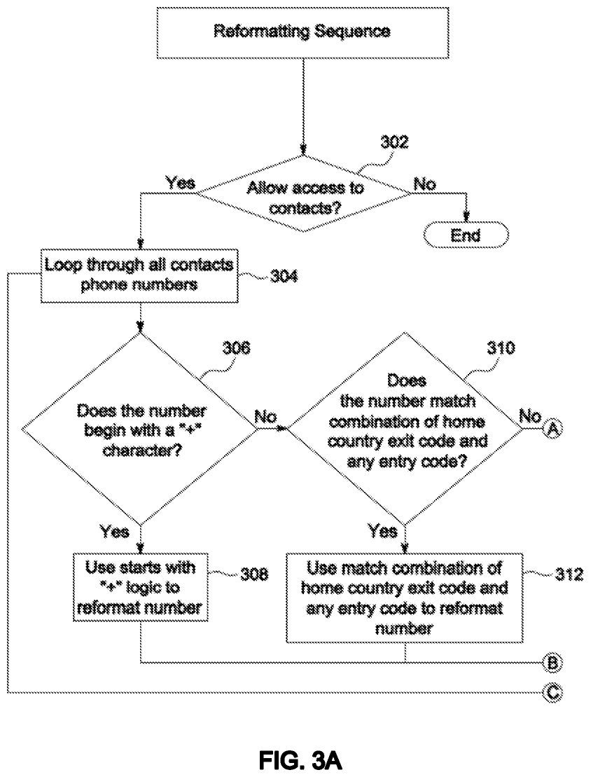

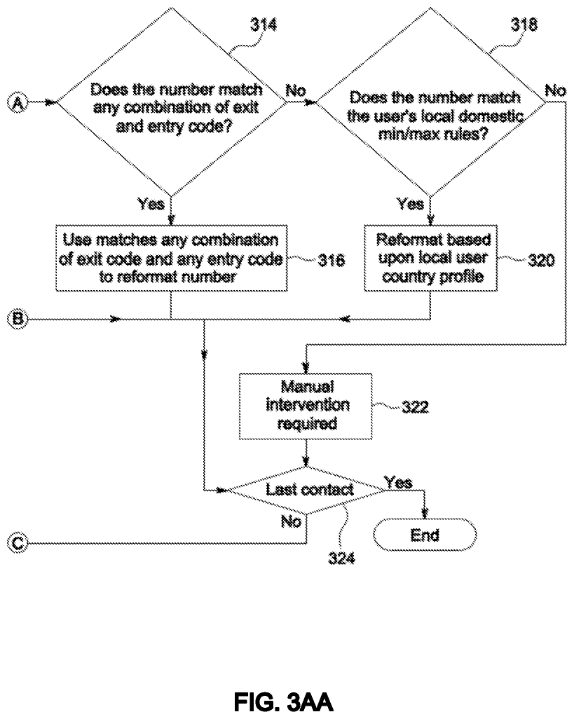

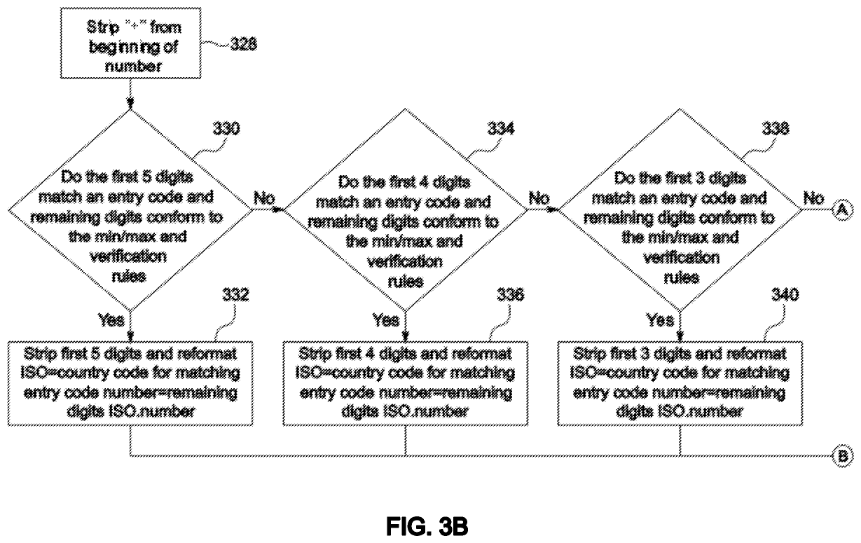

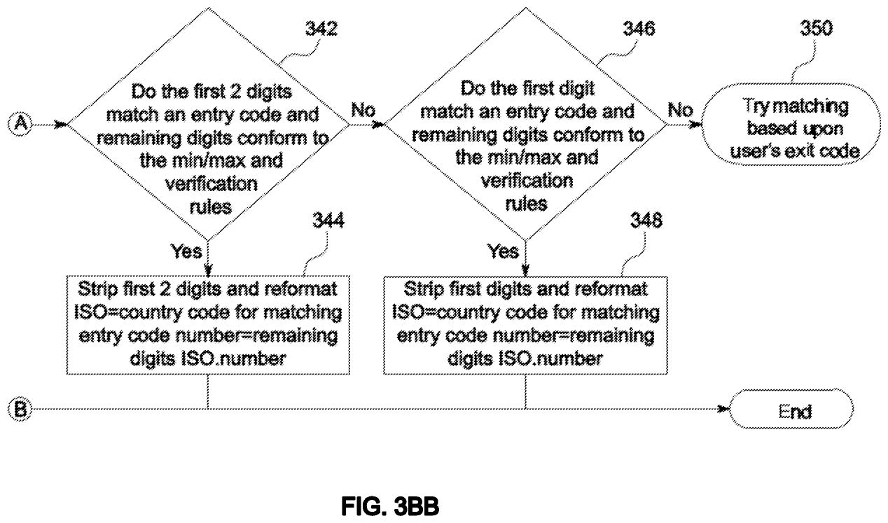

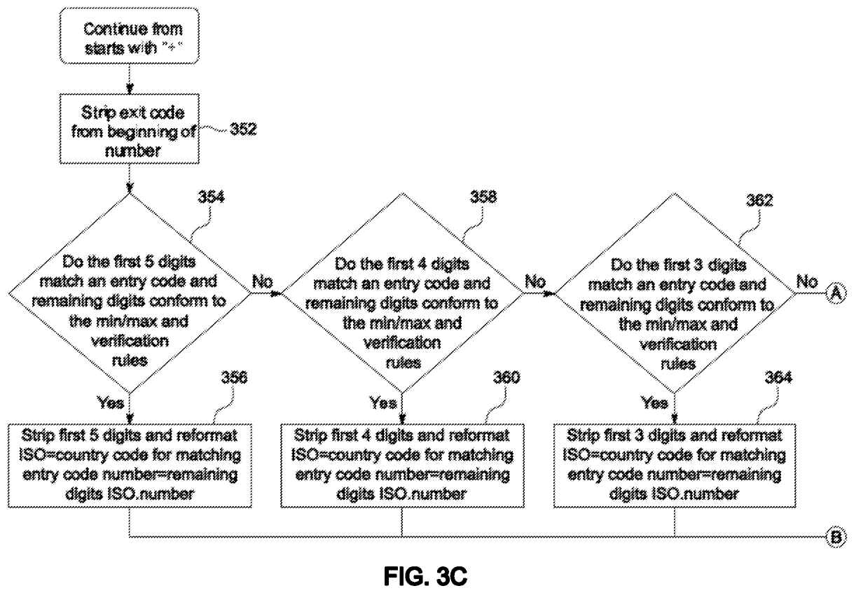

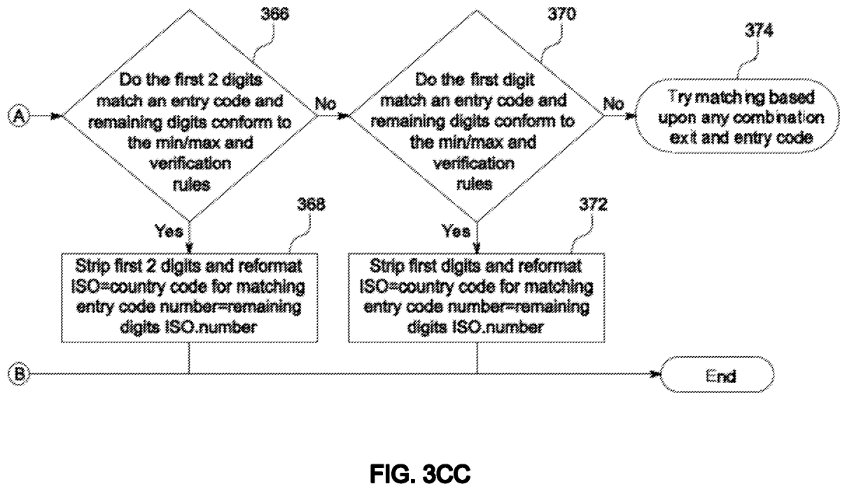

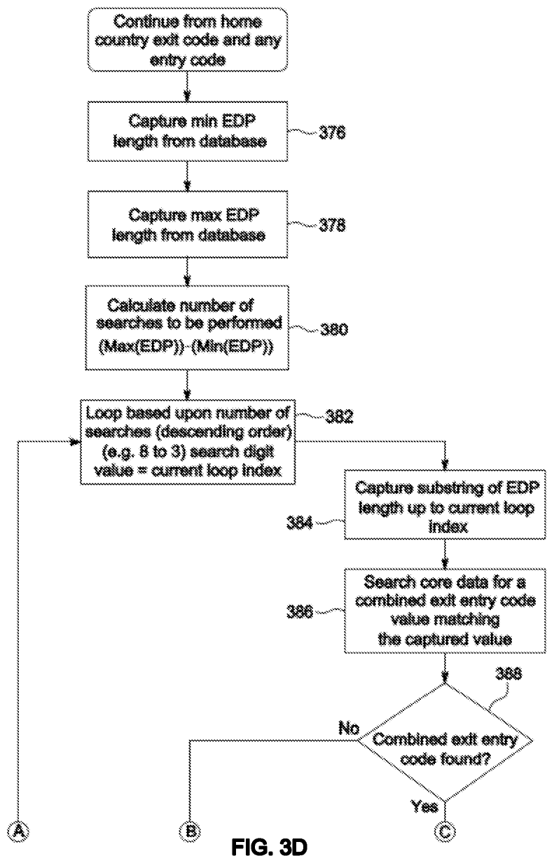

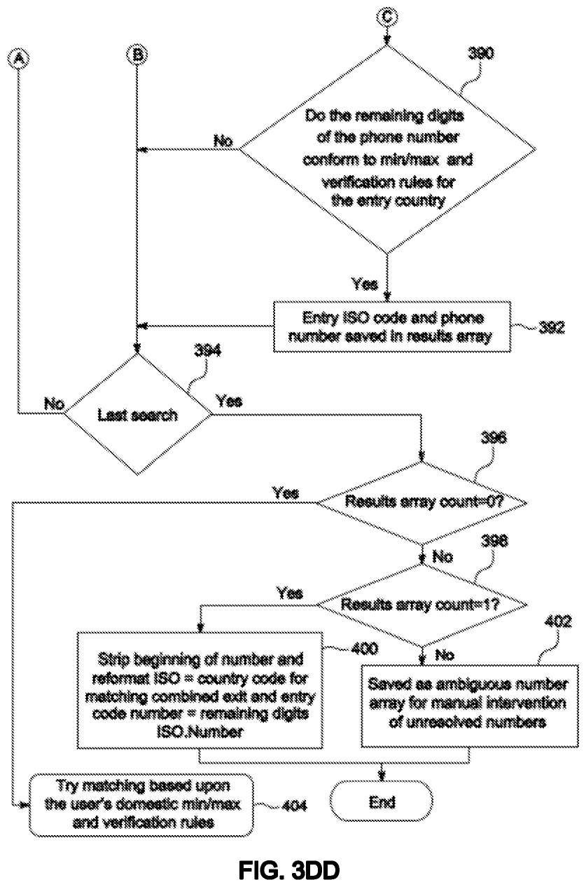

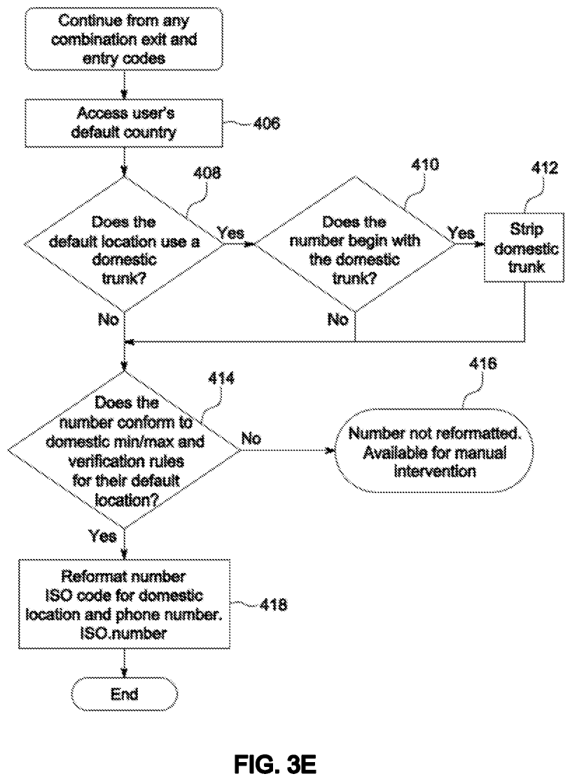

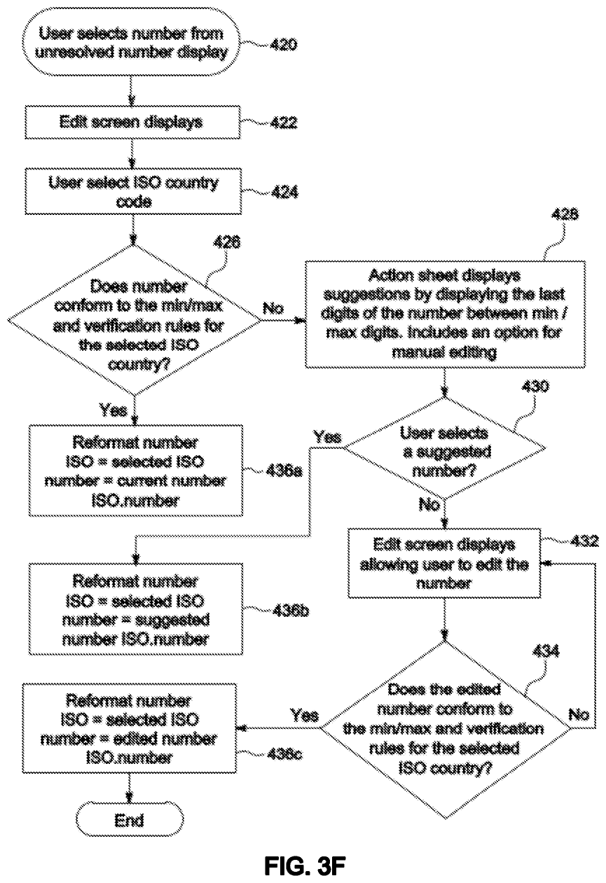

At block 110, the phone numbers in the contacts list may be converted to the TIN format. Reformatting of the contacts list is described in detail in FIGS. 3A to 3F. The process continues at block 112.

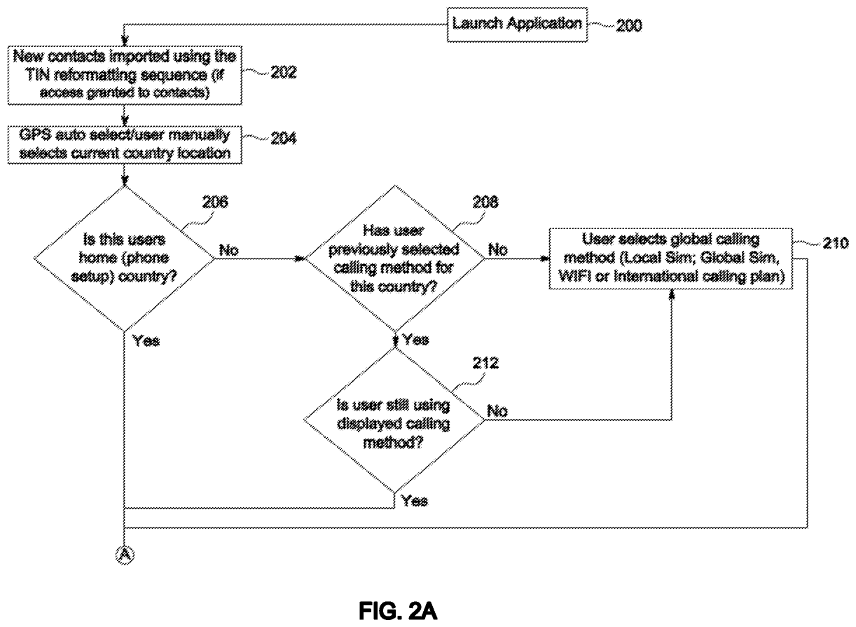

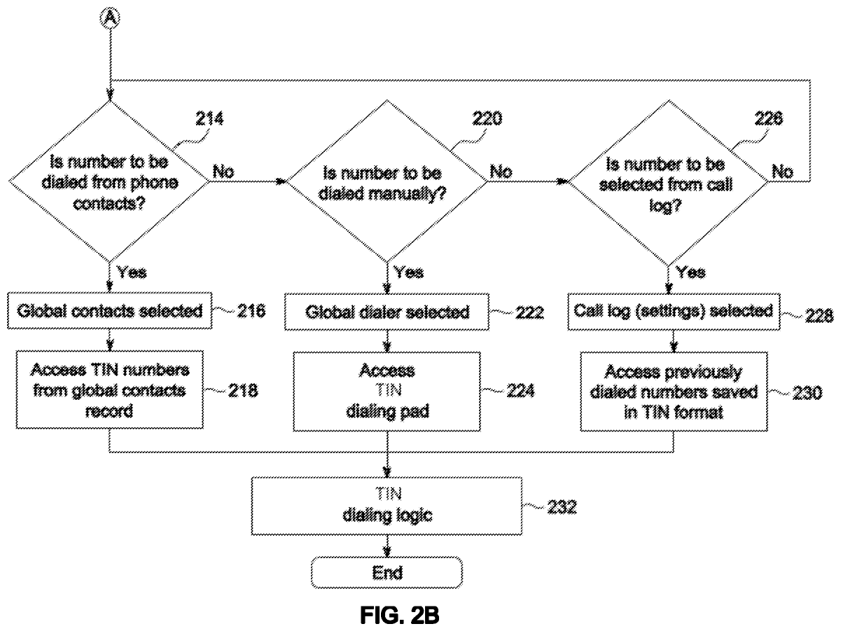

At block 112, the application may be launched on the mobile device. The launch of the application is described in detail in FIGS. 2A and 2B. Once the application is launched, new phone numbers are reformatted and added to the contacts list. The GPS may verify the country in which the user is located or the user may select the country in which he or she is located.

FIGS. 2A and 2B are a detailed process flow diagram of a method for launching an installed software application that converts a phone number to the TIN dialing format and then dials the reformatted phone number. FIGS. 2A and 2B are explained in the context of FIG. 1. The process begins at block 200.

At block 200, the application may be launched on the mobile device of a user. The process continues at block 202.

At block 202, new phone numbers may be converted to the TIN format and added to the contacts list on the mobile device if access to the contacts list was allowed at block 108 of FIG. 1. Reformatting of new phone numbers is described in detail in FIG. 3A. The process continues at block 204.

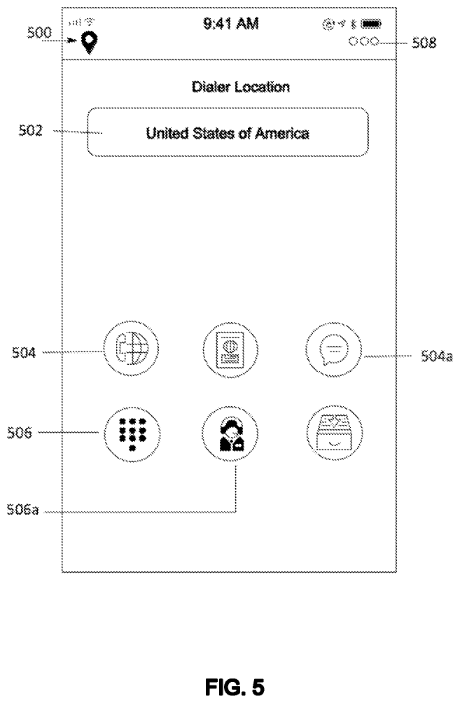

At block 204, the GPS may verify that the mobile device has correctly identified the country in which the user is located. Alternatively, the user may select the country in which he or she is located. Block 204 is explained in detail in FIG. 5. The process continues with the query at block 206.

At block 206, the home country of the user (i.e., the country in which the mobile device was configured) is compared to the current country of the user (i.e., the country in which the user is presently located). If the two countries are the same, the process continues at block 214. If the two countries are different, the process continues with the query at block 208.

At block 208, it is determined whether the user may have previously selected a calling method for the current country. If a calling method has not been selected, the process continues at block 210. If a calling method has been selected, the process continues with the query at block 212. At block 212, the application may determine if the user is still using the calling method selected when the mobile device was configured. If the user is still using the selected calling method, the process continues with the query at block 214. If the user is not using the selected calling method, the process continues at block 210.

At block 210, the user may select a global calling method to be used in his or her current country. The user may choose from a local SIM card, a global SIM card, a Wi-Fi application, an international calling plan, or any other suitable calling method. The process continues with the query at block 214.

At block 214, it is determined whether a phone number may be dialed from the contacts list on the user's mobile device. If the phone number cannot be dialed from the contacts list, the process continues at block 220. If the phone number can be dialed from the contacts list, the process continues at block 216.

At block 216, the user may select the contacts list on his or her mobile device. The process continues at block 218.

At block 218, a phone number in the TIN format may be accessed from the contacts list. The process continues at block 232.

At block 214, if the phone number cannot be dialed from the contacts list, the process continues with the query at block 220. At block 220, it is determined if the phone number may be dialed manually. If the phone number cannot be dialed manually, the process continues with the query at block 226. If the phone number can be dialed manually, the process continues at block 222.

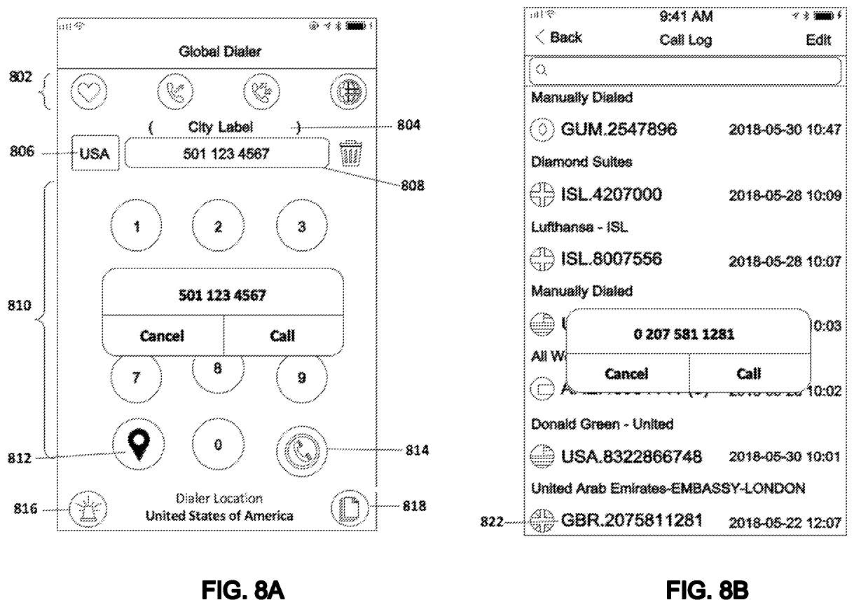

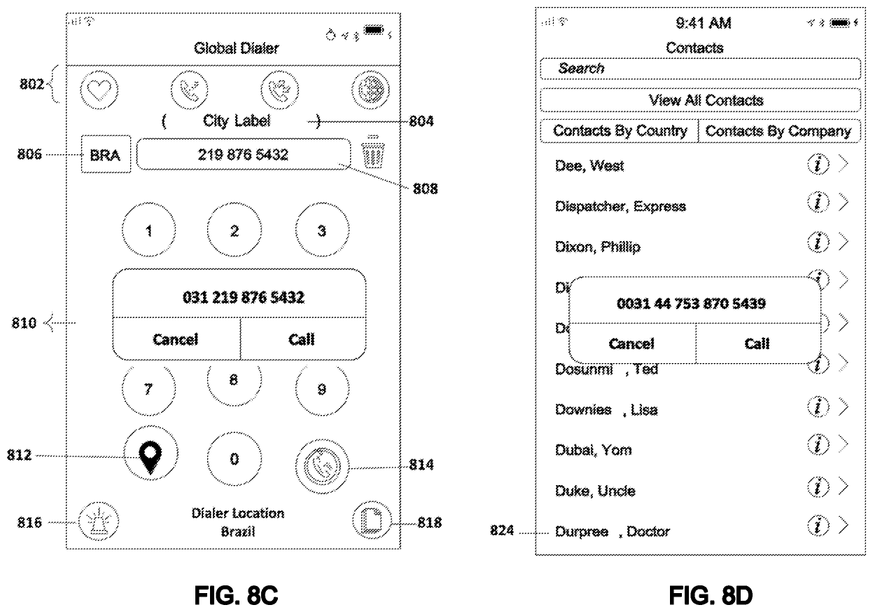

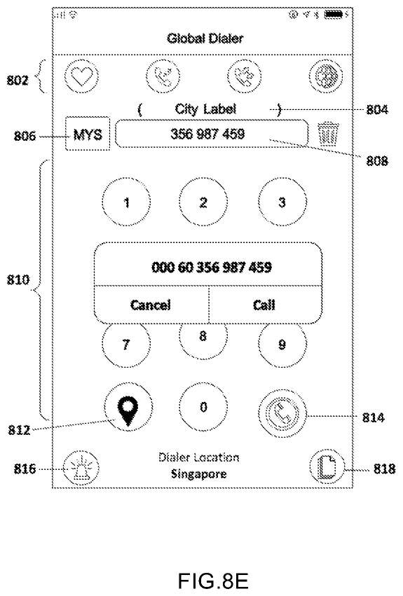

At block 222, the global dialer may be selected by the user. The user selects the interface for the global dialer from the home screen of the mobile device. The home screen is shown in FIG. 5. The user then selects the country to be dialed as explained in FIG. 8. The process continues at block 224.

At block 224, the user may access a TIN dialing pad (interface) and enter the number to be dialed. The process continues at block 232.

At block 220, if the phone number cannot be dialed manually, the process continues with the query at block 226. At block 226, it is determined if the phone number may be selected from the call log. The call log contains previously dialed phone numbers. If the phone number cannot be selected from the call log, the process continues with the query at block 214. If the phone number can be selected from the call log, the process continues at block 228.

At block 228, the user may select the call log from the dialing pad shown in FIG. 8. The process continues at block 230.

At block 230, the user may access the previously dialed phone numbers saved in the TIN format and select the phone number to be dialed. The process continues at block 232.

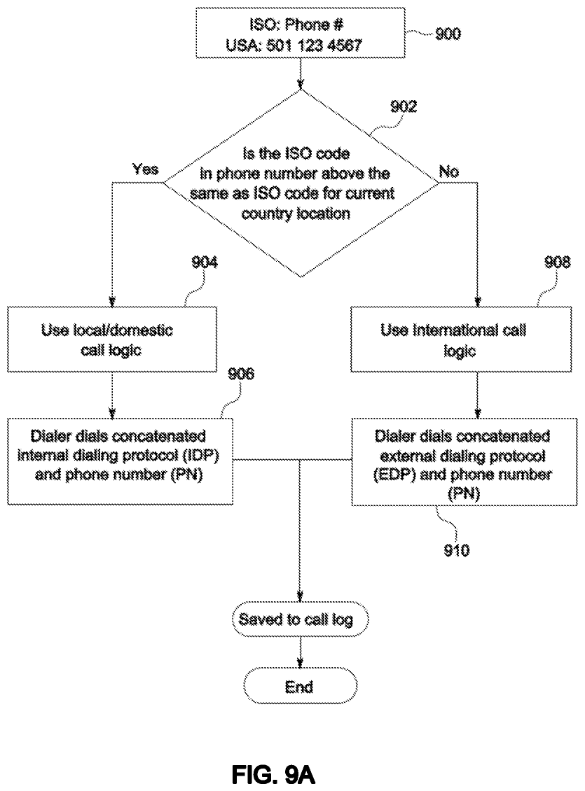

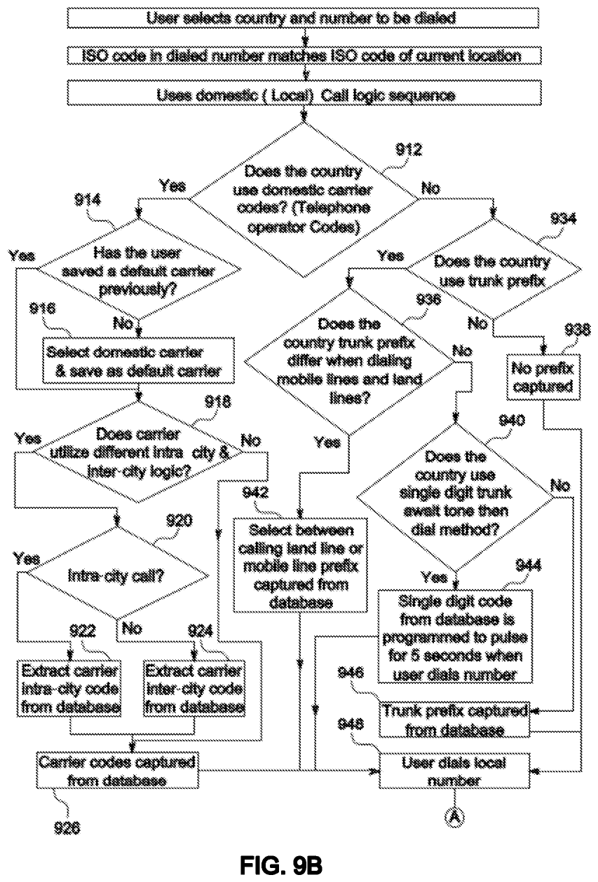

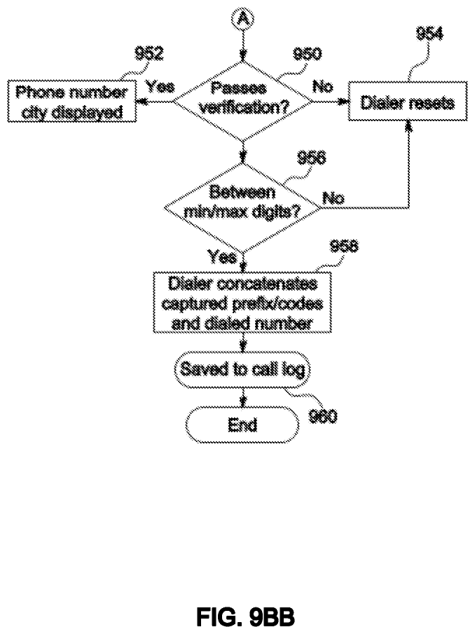

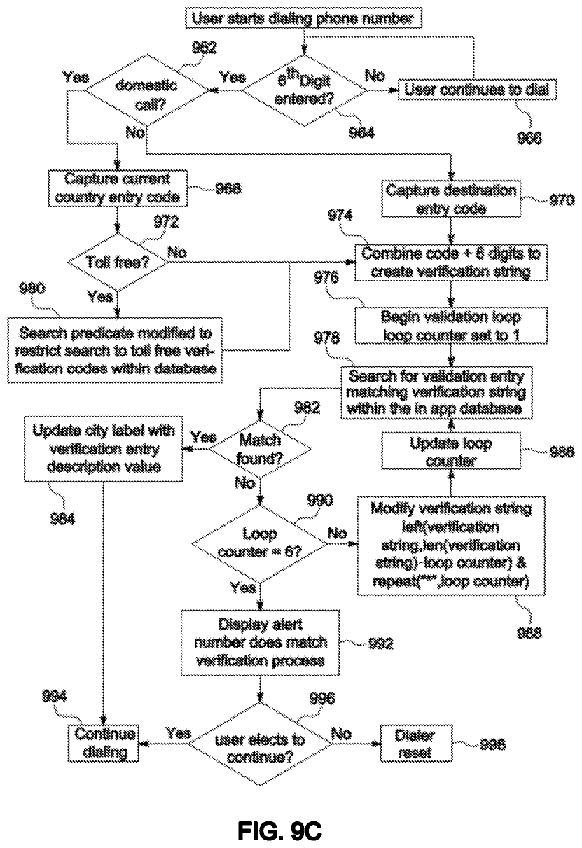

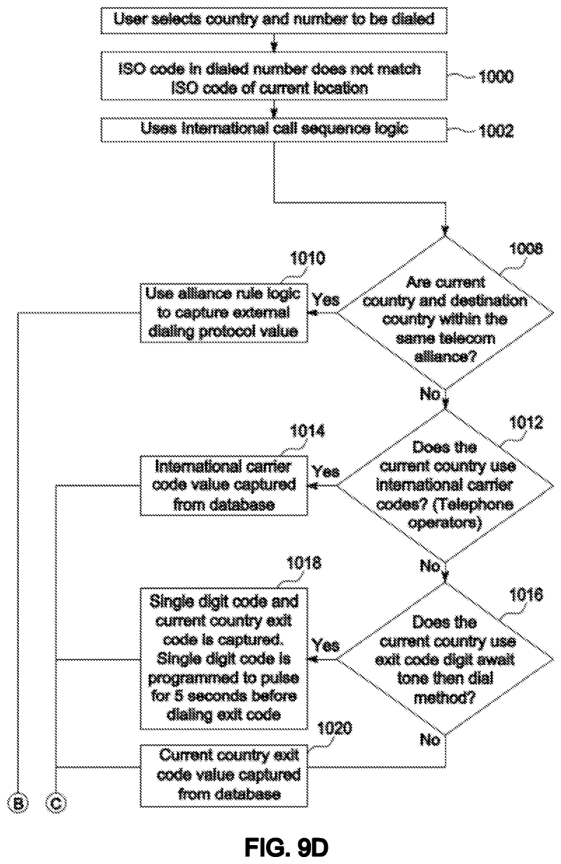

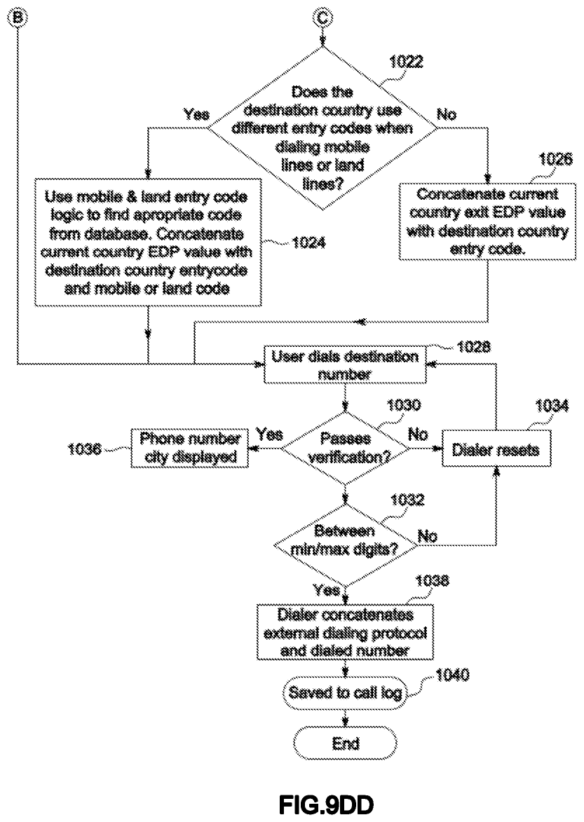

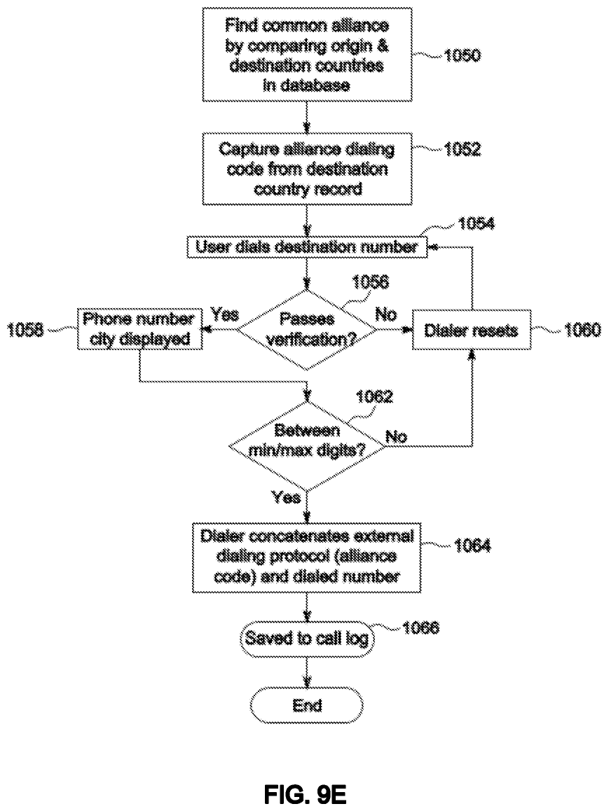

At block 232, TIN dialing logic is executed by the mobile device. TIN dialing logic is explained in detail in FIGS. 9A to 9E. The process ends after execution of the TIN dialing logic.

FIGS. 3A and 3AA are a detailed process flow diagram of a method for reformatting domestic and international phone numbers. In particular, the phone numbers are converted to the TIN format. FIGS. 3A and 3AA are explained in the context of FIGS. 1 and 2. The process begins with the query at block 302.

At block 302, it is determined whether the application may access the contacts list on the user's mobile device. If access is not allowed, the process ends. If access is allowed, the process continues at block 304.

At block 304, the application may begin to loop through the phone numbers in the contacts list on the user's mobile device. The first step in the loop is the query at block 306.

At block 306, it is determined whether the phone number begins with a “+” symbol. The “+” symbol is the exit code for most countries. An exit code is a prefix which must be dialed when placing an international call. Exit codes are also known as international call prefixes and dial-out codes.

At block 306, if the phone number does not begin with the “+” symbol, the process continues with the query at block 310. If the phone number begins with the “+” symbol, the process continues at block 308.

At block 308, “+” logic may be used to reformat the number. This block is explained in detail in FIGS. 3B and 3BB. The process continues with the query at block 324.

If the phone number does not begin with the “+” symbol, the process continues with a query at block 310. At block 310, it is determined whether the phone number matches a combination of the exit code for the user's home country and any entry code. An entry code signifies which foreign country is to be called. The entry code for a country may contain three digits at most. The terms “entry code” and “dial-in code” may be used interchangeably.

If the phone number matches a combination of the exit code for the user's home country and any entry code, the process continues at block 312. At block 312, the phone number may be reformatted using the combination of the exit code for the user's home country and the entry code for the foreign country to be called. Block 312 is explained in detail in FIG. 3C. The process continues with the query at block 324.

If the phone number does not match a combination of the exit code for the user's home country and any entry code, the process continues with the query at block 314. At block 314, the application determines whether the phone number matches any combination of an exit code different from the exit code for the user's home country and any entry code. If a match is found at block 314, the process continues at block 316.

At block 316, the phone number may be reformatted using the combination of the exit code different from the exit code for the user's home country and the entry code. Block 316 is explained in detail in FIG. 3D. The process continues with the query at block 324.

If a match is not found at block 314, the process continues with the query at block 318. At block 318, it is determined whether the phone number satisfies the MMR for the user's home country. If the phone number does not satisfy the MMR, the process continues at block 304 for another iteration of the loop. If the phone number satisfies the MMR, the process continues at block 320.

At block 320, the phone number may be reformatted using the country profile for the user's home country. A country profile is a set of rules used to format domestic phone numbers. Block 320 is explained in detail in FIG. 3E. The process continues at block 322.

At block 322, manual intervention may be required to reformat the phone number. Manual intervention is necessary when a domestic phone number is saved incorrectly (i.e., does not conform to the domestic dialing protocol), when an international phone number is saved in an incorrect format, or when the phone number is an ambiguous number.

An ambiguous phone number is a number that conforms to the MMR and the verification sequence for two or more countries. For example, the phone number “0096536745987” may be construed as containing the exit code “00” for Great Britain and the entry code “965” for Kuwait. The remainder “36745987” conforms to the MMR and the verification sequence process for Kuwait. The same phone number may be construed as containing the exit code “009” for Nigeria and the entry code “65” for Singapore. The remainder “36745987” also conforms to the MMR and the verification sequence for Singapore. Thus, “0096536745987” could be a phone number in Kuwait or Singapore.

After the manual intervention at block 322, the process continues with the query at bock 324. At block 324, it is determined whether the phone number is the last contact in the contacts list on the user's mobile device. If the phone number is not the last contact, the process continues at block 304 for another iteration of the loop. The process ends if the phone number is the last contact; no more iterations of the loop are necessary.

FIGS. 3B and 3BB are a detailed process flow diagram of a method for converting phone numbers starting with a “+” symbol to the TIN format. FIGS. 3B and 3BB are explained in the context of FIGS. 1 to 3AA.

The process starts at block 328, where the “+” symbol may be stripped from a phone number in the contacts list on the user's mobile device. The process continues with the query at block 330.

At block 330, the application determines whether the first five digits of the phone number match the entry code for a country and the remaining digits conform to the MMR and verification sequence for that country. In an embodiment, the first five digits of the phone number are compared to the entry codes in the dialing codes database. (See FIGS. 12A and 12B.) If the first five digits match the entry code for a country, the remaining digits are compared to the MMR and the verification sequence for that country. The process continues at block 332 if the first five digits of the phone number match the entry code for a country and the remaining digits conform to the MMR and the verification sequence for that country.

At block 332, the first five digits may be stripped from the phone number and converted to the ISO code for the country to be called. The phone number is converted to the TIN format “ISO.number” where “ISO” corresponds to the destination country's ISO code and “number” corresponds to the digits remaining after the first five digits of the phone number are removed. After the phone number has been reformatted, the process ends.

The process continues with the query at block 334 if the first five digits of the phone number and the remaining digits do not satisfy the conditions specified in the query at block 330. At block 334, it is determined whether the first four digits of the phone number match the entry code for a country and the remaining digits conform to the MMR and the verification sequence for that country. The process continues at block 336 if the first four digits of the phone number and the remaining digits satisfy the conditions specified in the query at block 334.

At block 336, the first four digits may be stripped from the phone number and converted to the ISO code for the country to be called. The phone number is converted to the TIN format “ISO.number” where “ISO” corresponds to the destination country's ISO code and “number” corresponds to the digits remaining after the first four digits of the phone number are removed. After the phone number has been reformatted, the process ends.

The process continues with the query at block 338 if the first four digits of the phone number and the remaining digits do not satisfy the conditions specified in the query at block 334. At block 338, it is determined whether the first three digits of the phone number match the entry code for a country and the remaining digits conform to the MMR and the verification sequence for that country. The process continues at block 340 if the first three digits of the phone number and the remaining digits satisfy the conditions specified in the query at block 338.

At block 340, the first three digits may be stripped from the phone number and converted to the ISO code for the country to be called. The phone number is converted to the TIN format “ISO.number” where “ISO” corresponds to the destination country's ISO code and “number” corresponds to the digits remaining after the first three digits of the phone number are removed. After the phone number has been reformatted, the process ends.

The process continues with the query at block 342 if the first three digits of the phone number and the remaining digits do not satisfy the conditions specified in the query at block 338. At block 342, it is determined whether the first two digits of the phone number match the entry code for a country and the remaining digits conform to the MMR and the verification sequence for that country. The process continues at block 344 if the first two digits of the phone number and the remaining digits satisfy the conditions specified in the query at block 342.

At block 344, the first two digits may be stripped from the phone number and converted to the ISO code for the country to be called. The phone number is converted to the TIN format “ISO.number” where “ISO” corresponds to the destination country's ISO code and “number” corresponds to the digits remaining after the first two digits of the phone number are removed. After the phone number has been reformatted, the process ends.

The process continues with the query at block 346 if the first two digits of the phone number and the remaining digits do not satisfy the conditions specified in the query at block 342. At block 346, it is determined whether the first digit of the phone number matches the entry code for a country and the remaining digits conform to the MMR and the verification sequence for that country. The process continues at block 348 if the first digit of the phone number and the remaining digits satisfy the conditions specified in the query at block 346.

At block 348, the first digit may be stripped from the phone number and converted to the ISO code for the country to be called. The phone number is converted to the TIN format “ISO.number” where “ISO” corresponds to the destination country's ISO code and “number” corresponds to the digits remaining after the first digit of the phone number is removed. After the phone number has been reformatted, the process ends.

The process continues at block 350 if the first digit of the phone number and the remaining digits do not satisfy the conditions specified in the query at block 346. At block 350, the phone number may be matched to a phone number starting with the exit code for the user's home country.

FIGS. 3C and 3CC are a detailed process flow diagram of a method for converting a phone number starting with the exit code for a user's home country to the TIN format. FIGS. 3C and 3CC are explained in the context of FIGS. 1 to 3BB.

The process starts at block 352, where the exit code for the user's home country is stripped from the beginning of a phone number in the contacts list on the user's mobile device. The process continues with the query at block 354.

At block 354, the application determines whether the first five digits of the phone number (minus the exit code) match the entry code for a country and the remaining digits conform to the MMR and the verification sequence for that country. In an embodiment, the first five digits of the phone number are compared to the entry codes in the dialing codes database. (See FIGS. 12A and 12B.) If the first five digits match the entry code for a country, the remaining digits are compared to the MMR and the verification sequence for that country. The process continues at block 356 if the first five digits of the phone number satisfy the conditions specified in the query at block 354.

At block 356, the first five digits may be stripped from the phone number and converted to the ISO code for the country to be called. The phone number is converted to the TIN format “ISO.number” where “ISO” corresponds to the destination country's ISO code and “number” corresponds to the digits remaining after the first five digits of the phone number are removed. After the phone number has been reformatted, the process ends.

The process continues with the query at block 358 if the first five digits of the phone number and the remaining digits do not satisfy the conditions specified in the query at block 354. At block 358, it is determined whether the first four digits of the phone number (minus the exit code) match the entry code for a country and the remaining digits conform to the MMR and the verification sequence for that country. The process continues at block 360 if the first four digits of the phone number and the remaining digits satisfy the conditions specified in the query at block 358.

At block 360, the first four digits may be stripped from the phone number and converted to the ISO code for the country to be called. The phone number is converted to the TIN format “ISO.number” where “ISO” corresponds to the destination country's ISO code and “number” corresponds to the digits remaining after the first four digits of the phone number are removed. After the phone number has been reformatted, the process ends.

The process continues with the query at block 362 if the first four digits of the phone number and the remaining digits do not satisfy the conditions specified in the query at block 358. At block 362, it is determined whether the first three digits of the phone number (minus the exit code) match the entry code for a country and the remaining digits conform to the MMR and the verification sequence for that country. The process continues at block 364 if the first three digits of the phone number and the remaining digits satisfy the conditions specified in the query at block 362.

At block 364, the first three digits may be stripped from the phone number and converted to the ISO code for the country to be called. The phone number is converted to the TIN format “ISO.number” where “ISO” corresponds to the destination country's ISO code and “number” corresponds to the digits remaining after the first three digits of the phone number are removed. After the phone number has been reformatted, the process ends.

The process continues with the query at block 366 if the first three digits of the phone number and the remaining digits do not satisfy the conditions specified in the query at block 362. At block 366, it is determined whether the first two digits of the phone number (minus the exit code) match the entry code for a country and the remaining digits conform to the MMR and verification sequence for that country. The process continues at block 368 if the first two digits of the phone number and the remaining digits satisfy the conditions specified in the query at block 366.

At block 368, the first two digits may be stripped from the phone number and converted to the ISO code for the country to be called. The phone number is converted to the TIN format “ISO.number” where “ISO” corresponds to the destination country's ISO code and “number” corresponds to the digits remaining after the first two digits of the phone number are removed. After the phone number has been reformatted, the process ends.

The process continues with the query at block 370 if the first two digits of the phone number and the remaining digits do not satisfy the conditions specified in the query at block 366. At block 370, it is determined whether the first digit of the phone number (minus the exit code) matches the entry code for a country and the remaining digits conform to the MMR and the verification sequence for that country. The process continues at block 372 if the first digit of the phone number and the remaining digits satisfy the conditions specified in the query at block 370.

At block 372, the first digit may be stripped from the phone number and converted to the ISO code for the country to be called. The phone number is converted to the TIN format “ISO.number” where “ISO” corresponds to the destination country's ISO code and “number” corresponds to the digits remaining after the first digit of the phone number is removed. After the phone number has been reformatted, the process ends.

The process continues at block 374 if the first digit of the phone number and the remaining digits do not satisfy the conditions specified in the query at block 370. At block 374, the phone number may be matched to any combination of an exit code and an entry code.

FIGS. 3D and 3DD are a detailed process flow diagram of a method for converting a phone number containing any combination of an exit code and an entry code to the TIN format. FIGS. 3D and 3DD are explained in the context of FIGS. 1 to 3CC.

In FIGS. 3D and 3DD, it is determined whether a phone number begins with any combination of an exit code and an entry code. In an embodiment, this could occur when a user of a mobile device visits another country, places an international phone call, and saves the phone number using the dialing protocol of the visited country.

The core data on a user's mobile device may include all possible combinations of exit codes and entry codes. An exit code and an entry code are combined to form an external dialing protocol (EDP). For example, consider a phone call placed from the United States to Poland. The exit code for the United States is “011” and the entry code for Poland is “48.” Hence, the EDP for this international call would be “01148.”

The method depicted in FIGS. 3D and 3DD begins at block 376, where the application may capture the minimum EDP length contained in the dialing codes database shown in FIGS. 12A and 12B. In an embodiment, the minimum EDP length may be 3. The process continues at block 378, where the application may capture the maximum EDP length contained in the dialing codes database. In an embodiment, the maximum EDP length may be 8. The process continues at block 380.

At block 380, the number of searches to be performed may be calculated as the difference between the maximum EDP length and the minimum EDP length. In an embodiment, the number of searches to be performed may be 5 (=8−3). The process continues at block 382.

At block 382, the application begins a loop. The number of loop iterations will equal the number of searches calculated at block 380. In an embodiment, the loop may iterate five times. The first iteration of the loop has a current loop index equal to the maximum EDP length. In an embodiment, the first iteration has a current loop index equal to 8. As the loop iterates, the current loop value will decrement until the number of iterations equals the number of searches calculated at block 380. In an embodiment, the second iteration of the loop will have a current loop index of 7 and the current loop index will continue to decrement until 5 iterations have been completed.

Block 384 is the first step in the loop. At block 384, the application may capture a substring of the EDP equal in length to the current loop index. The process continues at block 386.

At block 386, the core data on the user's mobile device may be searched for the combination of exit code and entry code that matches the captured substring of the EDP. The process continues with the query at block 388.

At block 388, it is determined whether a combination of exit code and entry code may be found that matches the captured sub string of the EDP. If a matching combination of exit code and entry code is not found, the process continues with the query at block 394. If a matching combination is found, the process continues with the query at block 390.

At block 390, it is determined whether the remaining digits of the phone number (minus the EDP) may conform to the MMR and the verification sequence for the country having the entry code in the sub string of the EDP. If the remaining digits do not satisfy the conditions specified in the query at block 390, the process continues with the query at block 394. If the remaining digits satisfy the specified conditions, the process continues at block 392.

At block 392, the entry code and the remaining digits of the phone number may be saved to a results array. The process continues with the query at block 394.

At block 394, it is determined whether the present search may be the last search. If the present search is not the last search, the process continues at block 382 with another iteration of the loop. If the present search is the last search, the process continues with the query at block 396.

At block 396, it is determined whether the results array count is equal to zero. If the results array count is equal to zero, the process continues at block 404.

At block 404, the application attempts to match the internal dialing protocol (IDP) to the MMR and the verification sequence for the user's home country. In other words, the application is searching for domestic phone numbers. If a domestic phone number is found, the phone number is converted to the TIN (“ISO.number”) format. Block 404 is explained in detail in FIG. 3E.

If the results array count is not equal to zero at block 396, the process continues with the query at block 398. At block 398, it is determined whether the results array count may be equal to 1. If the results array count is equal to 1, the process continues at block 400.

At block 400, the EDP may be stripped from the phone number and the number is reformatted. The phone number is converted to the TIN format “ISO.number” where “ISO” is the country code for the country having the entry code in the EDP and “number” is the digits of the phone number that remain after the EDP has been removed. After the phone number has been reformatted, the process ends.

If the results array count is not equal to 1 at block 398, the process may continue at block 402. At block 402, multiple phone numbers have been found during the series of searches. In an embodiment, the number of phone numbers may range from two to a maximum equal to the total number of searches performed. For example, if five searches were completed, the number of phone numbers found would range from two to five. The multiple phone numbers are saved to an ambiguous number array so that manual intervention can occur. After the multiple phone numbers have been saved, the process ends.

FIG. 3E is a process flow diagram of a method for converting domestic phone numbers to the TIN format. A domestic phone number may have a local or domestic trunk for the user's home country. FIG. 3E is explained in the context of FIGS. 1 to 3DD. The process begins at block 406.

At block 406, the user's default (home) country may be accessed in the table shown in FIGS. 12A and 12B. From the table, it is determined whether the phone numbers in the default country have a domestic trunk. The term “domestic trunk” refers to the digits that have to be dialed before a domestic phone number. A domestic trunk contains one to four digits. A country may have multiple domestic trunks. The terms “domestic trunk” and “local trunk prefix” may be used interchangeably.” The process continues with the query at block 408.

At block 408, the application determines whether phone numbers in the default country may have a domestic trunk. If the phone numbers have a domestic trunk, the process continues with the query at block 410. If the phone numbers do not have a domestic trunk, the process continues with the query at block 414.

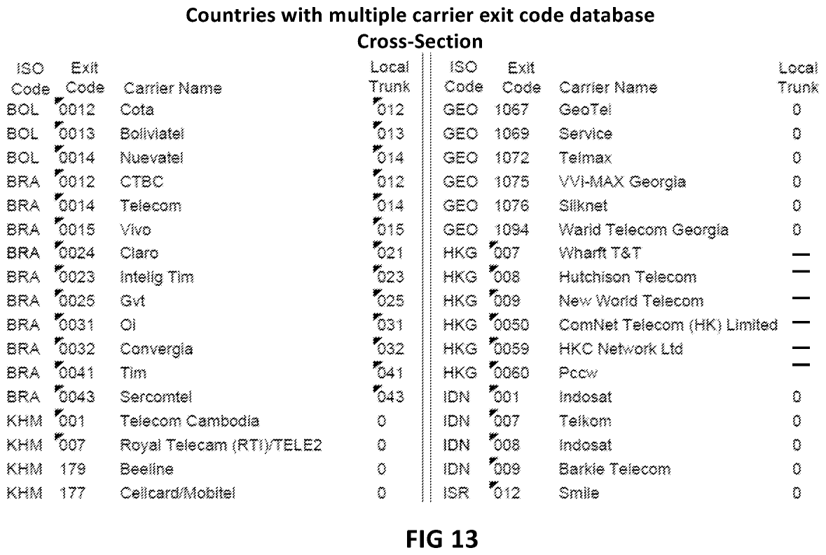

At block 410, it is determined whether a phone number may begin with the domestic trunk. In an embodiment, the domestic trunk is determined. Some countries may have different domestic trunks for dialing land lines and mobile lines. Some countries have different domestic trunks for dialing intra-city and inter-city phone numbers. Further, some countries have different domestic trunks for different telecommunication carriers. For example, as shown in FIG. 13, Brazil (BRA) has multiple telecommunication carriers and a different domestic trunk for each carrier.

If a phone number begins with a domestic trunk, the process continues at block 412. If the phone number does not begin with a domestic trunk, the process continues with the query at block 414.

At block 412, the domestic trunk may be stripped from the phone number. After the domestic trunk is removed, the process continues with the query at block 414.

At block 414, it is determined whether the remaining digits of the phone number may conform to the domestic MMR and the domestic verification sequence. If the remaining digits do not conform to the domestic MMR and verification sequence, the control passes to block 416. At block 416, manual intervention is required because the remaining digits of the phone number cannot be reformatted.

If the remaining digits of the phone number conform to the domestic MMR and verification sequence, the process continues at block 418. At block 418, the remaining digits of the phone number may be reformatted. The remaining digits are converted to the TIN format “ISO.number” where “ISO” is the country's ISO code and “number” is the digits that remain after the domestic trunk has been stripped. After the remaining digits are reformatted, the process ends.

FIG. 3F is a process flow diagram of a method for converting ambiguous phone numbers to the TIN format. An ambiguous phone number is a phone number that cannot be reformatted using previously described methods. Manual intervention is needed to convert these phone numbers to the TIN format. The terms “ambiguous number” and “unresolved number” may be used interchangeably. FIG. 3F is explained in the context of FIGS. 1 to 3E.

The process for converting unresolved phone numbers to the TIN format begins at block 420. At block 420, the user may select a phone number from the list of unresolved phone numbers displayed on the user's device. The process continues at block 422, where the user edits the settings for the display screen on his or her mobile device. After the settings have been edited, the process continues at block 424.

At block 424, the user may select the ISO code for the destination country associated with the unresolved phone number. After the ISO code has been selected, the process continues with the query at block 426.

At block 426, it is determined whether the unresolved phone number may conform to the MMR and the verification sequence for the country having the ISO code selected by the user at block 424. The MMR for the selected country is found in the dialing codes database shown in FIGS. 12A and 12B. The verification sequence for the selected country is found in the verification database shown in FIG. 11. If the phone number conforms to the MMR and the verification sequence, the process continues at block 436a.

At block 436a, the phone number may be reformatted. The phone number is converted to the TIN format “ISO.number” where “ISO” is the country code selected by the user and “number” is the phone number.

If the phone number does not conform to the MMR and the verification sequence for the selected country, the process continues at block 428. At block 428, the mobile device may display all possible combinations of the last digits of the phone number. The lengths of the digit strings range from the minimum permissible length to the maximum permissible length specified in the MMR for the selected country. The user may select a suggested sequence of digits. The process continues with the query at block 430.

At block 430, it is determined whether the user may have selected a suggested sequence of digits. If the user has selected a suggested sequence, the process continues at block 436b.

At block 436b, the selected sequence of digits is reformatted. The selected sequence is converted to the TIN format “ISO.number” where “ISO” is the ISO code for the country selected by the user and “number” is the sequence of digits selected by the user.

If the user has not selected a suggested sequence of digits, the process continues at block 432. At block 432, the user may manually edit any of the suggested sequences using an edit screen on the user's mobile device. The process continues with the query at block 434.

At block 434, it is determined whether the edited sequence of digits may conform to the MMR and the verification sequence for the selected country. If the edited sequence does not conform to the MMR and the verification sequence, the process returns to block 432. At block 432, the user resumes editing of the selected sequence of digits. When the user is finished editing, the process continues with the query at block 434. At block 434, it is determined whether the newly edited sequence of numbers conforms to the MMR and the verification sequence for the selected country. If the newly edited sequence does not conform to the MMR and the verification sequence, the process once again returns to block 432. Execution of blocks 432 and 434 continues until the editing of the selected sequence yields a sequence of digits that conforms to the MMR and the verification sequence for the selected country. Once editing results in a conforming sequence of digits, the process continues at block 436c.

At block 436c, the conforming sequence of digits may be reformatted. The sequence is converted to the TIN format “ISO.number” where “ISO” is the country code selected by the user and “number” is the conforming sequence of digits. The process ends once the sequence has been reformatted.

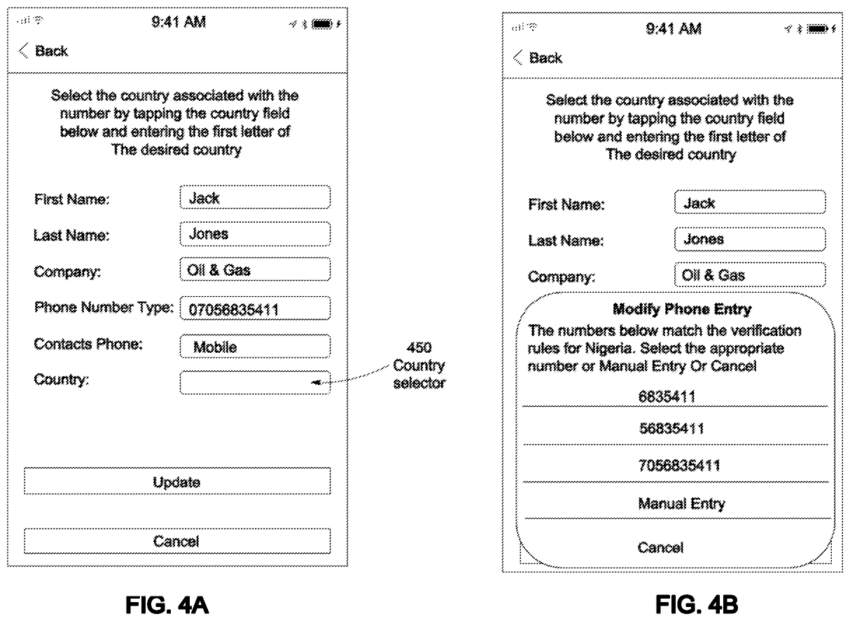

FIG. 4A is an illustration of a country selector screen of the mobile application used during the manual intervention process. FIG. 4A is an illustration of a country selector screen displayed on a user's mobile device. The screen may be used when manual intervention is needed to reformat a phone number. FIG. 4A is explained in conjunction with FIGS. 1 to 3F.

In an embodiment, the phone number “07056835411” is determined to be unresolved. The user may tap the country field and enter the first few letters of the name of the country associated with the phone number. When the desired country appears in the country field, the user may select the country using the country selector 450. For example, the country selected may be Nigeria. The record for Jack Jones is updated accordingly.

FIG. 4B is an illustration of a screen of the mobile application displaying unresolved phone numbers. FIG. 4B is explained in the context of FIGS. 1 to 4A. For example, Nigeria may be the country selected using the country selector 450 shown in FIG. 4A. The screen shown in FIG. 4B displays the stored phone numbers that satisfy the MMR and the verification sequence for Nigeria.

The user may select one of the three phone numbers displayed on the screen. For example, the user may select the phone number “7056835411.” The selected phone number is reformatted. It is converted to NGA.7056835411 (TIN format) where NGA is the ISO code for Nigeria and “7056835411” is the selected phone number. If the user does not select one of the displayed phone numbers, he or she may select either the manual entry option or the cancel option.

FIG. 5 is an illustration of a home screen of the mobile application. FIG. 5 is explained in the context of FIGS. 1 to 4B.

The home screen may appear once the application has launched. The GPS automatic country locator 500 may detect the user's location and compare it to the user's home country (specified during configuration of the mobile device). If the user's location matches his or her home country, the user may make phone calls by selecting phone numbers from his or her global contacts 504.

The GPS automatic country locator 500 may not function if Wi-Fi is unavailable or if phone data is lacking (i.e., the mobile device was configured incorrectly). If the GPS automatic country locator 500 is not functioning, the user may tap the manual current location selector 502 and enter his or her current location (i.e., current country).

The dialing of international phone calls may be simulated using dial mode 506a. This feature allows a user to determine how the application would dial international phone numbers originating in different countries. For example, a user located in the United States could simulate the dialing of international phone calls as if he or she were in Germany. A user can determine if the application dials international phone calls in accordance with the dialing protocols of different countries.

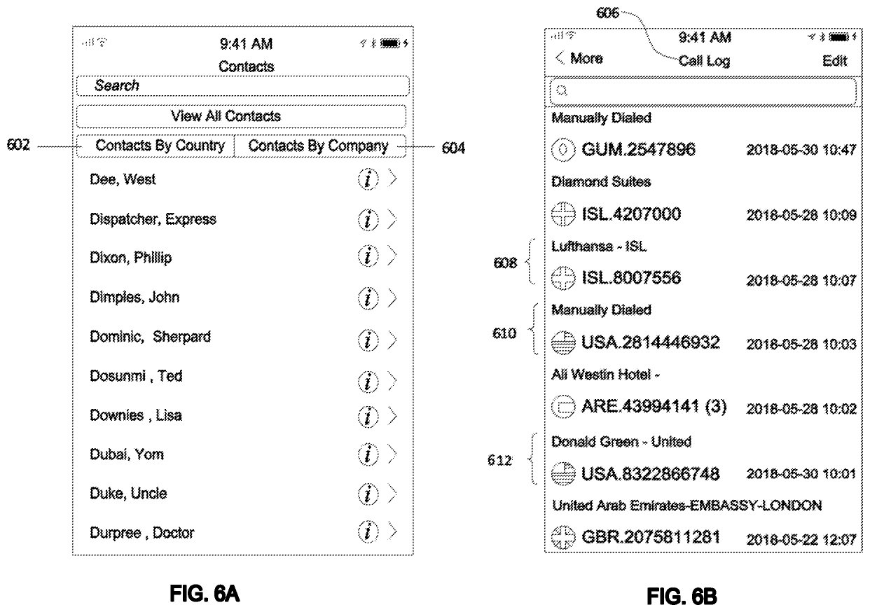

FIG. 6A is an illustration of a screen of the mobile application showing a contacts list prior to sorting. FIG. 6A is explained in the context of FIGS. 1 to 5. If “Contacts by Country” 602 is selected, the screen displays the contacts grouped by country. If “Contacts by Company” 604 is selected, the screen displays the contacts grouped by company.

FIG. 6B is an illustration of a screen of the mobile application showing a call log listing phone numbers saved in the TIN format. FIG. 6B is explained in the context of FIGS. 1 to 6A. In an embodiment, the screen displays a call log 606 where phone numbers are saved in the TIN format of “ISO.number.”

The call log 606 may display the international phone numbers dialed from the mobile device. In an embodiment, the international phone numbers 608 and 612 were dialed by selecting the phone numbers from the global contacts list and the international phone number 610 was manually dialed using the global dialer.

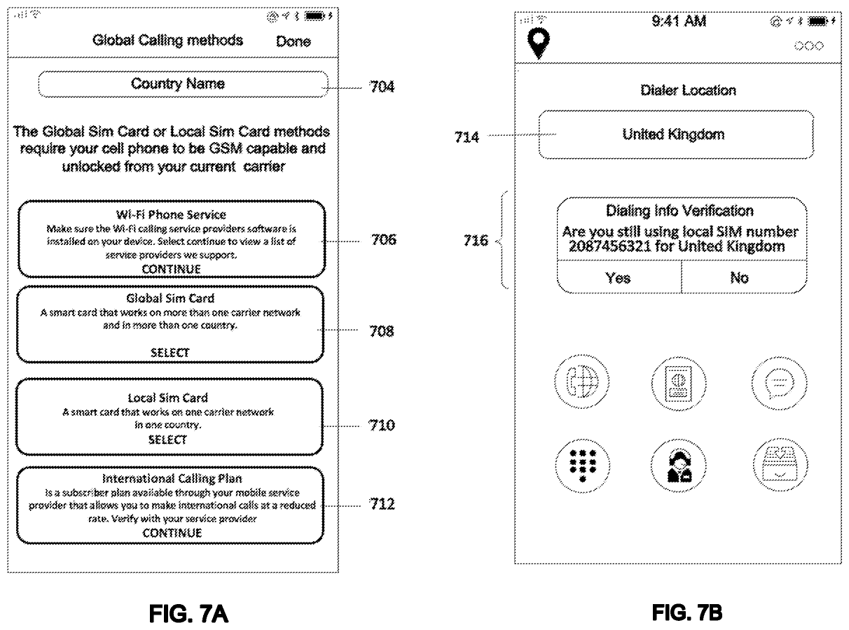

FIG. 7A is an illustration of a screen of the mobile application showing global calling methods available on a mobile device. FIG. 7A is explained in the context of FIGS. 1 to 6B. In an embodiment, the screen shown may appear when the user's current location differs from his or her home country. The screen allows the user to select a method for calling the phone numbers saved in the TIN format. The calling methods may include Wi-Fi phone applications 706, a global SIM card 708, a local SIM card 710, and an international calling plan 712.

The Wi-Fi phone applications 706 are dialing applications that use a Wi-Fi network in conjunction with a global data plan or a global hotspot provider 702. The global SIM card 708 provides mobile phone service in multiple countries. The international calling plan 712 provides the user with dialing privileges in other countries. The local SIM card 710 works in a single country. In some countries, SIM providers (telecommunication carriers) have their own exit codes. As a result, multiple exit codes may be available in certain countries. Countries with multiple exit codes include Australia, Bolivia, Brazil, Cambodia, Chile, Colombia, Fiji, Finland, Georgia, Hong Kong, Indonesia, Israel, Palau, Peru, Singapore, South Korea, Taiwan, and Thailand.

When the local SIM card 710 is selected, a list of local telecommunication carriers may be displayed. In an embodiment, the user may select a carrier. The database shown in FIG. 13 may be accessed to determine the exit code for the carrier selected by the user.

FIG. 7B is an illustration of a screen of the mobile application showing an alert related to a calling method. FIG. 7B is explained in the context of FIGS. 1 to 7A. In an embodiment, the user may have traveled to the United Kingdom in the past. While there, the user may have selected a local SIM card as the calling method.

When the user returns to the UK, the term “United Kingdom” may appear in the current location field 714. The user's mobile device may remember that a local SIM card was used during the user's previous visit to the United Kingdom. The mobile device may issue an alert 716 asking whether the user wants to use the local SIM card during his or her current visit. If the user selects “Yes,” the local SIM card is once again the selected calling method. If the user selects “No,” he or she is returned to the screen shown in FIG. 7A. From this screen, the user selects a different calling method.

FIG. 8A is an illustration of a screen of the mobile application showing a global dialer interface. FIG. 8A is explained in the context of FIGS. 1 to 7B. The global dialer interface may be used to manually dial both domestic and international phone numbers saved in the TIN format. A user information label 802 appears on the global dialer interface. A city label 804 also appears on the interface screen. The city label 804 displays the name of the destination city (i.e., the city that is the destination of the phone call). A country selector 806 allows the user to choose the ISO code for the destination country. In an embodiment, the country selector 806 may default to the ISO code for the user's current country. When this happens, the user may make domestic phone calls. A number display 808 shows the domestic phone number that will be dialed. In particular, the number display 808 informs the user of the number of digits that must be dialed to satisfy the current country's dialing protocol. In FIG. 8A, a user located the United States is making a domestic phone call. The phone number to be dialed “5011234567” is shown in the number display 808. The displayed phone number indicates that ten digits must the dialed to satisfy the dialing protocol of the United States.

To place an international phone call, the user may tap the country selector 806 and choose the ISO code for the destination country. The number display 808 may show the international phone number that will be dialed. The displayed phone number indicates the number of digits necessary to satisfy the destination country's dialing protocol. The phone call is completed by dialing the necessary number of digits. The country selector 806 may revert to the ISO code for the user's current country after an international phone call has been made.

Other features of the global dialer may include a dialing interface or keypad 810. When a user enters a series of digits using the dialing interface 810, the mobile device issues an alert showing the series of digits. The user selects “Call” if the series of digits constitutes the phone number the user wants to call. The user selects “Cancel” if the series of digits is not the desired phone number (i.e., if the user inadvertently entered a different series of digits).

The global dialer may include a GPS location selector 812 and a dialer 814. The interface for the global dialer may also include an icon for emergency numbers 816 and an icon for a phone directory 818. If the icon for emergency numbers 816 is selected, the screen displays emergency numbers for the user's current location. If the icon for a phone directory 818 is selected, the screen displays phone directories available in the destination country.

FIG. 8B is an illustration of a screen of the mobile application showing a call log interface. FIG. 8B is an illustration of a screen used to make a domestic phone call from a call log. FIG. 8B is explained in the context of FIGS. 1 to 8A.

In an embodiment, a user may travel to the United Kingdom and place a domestic phone call. The desired phone number may be saved in the TIN format in the call log on the mobile device. The user may access the call log and select a previously dialed phone number GBR.2075811281. The phone number will be dialed as a domestic phone call because the user's current location matches the country corresponding to the ISO code in the TIN-formatted phone number. A local call logic sequence is initiated as illustrated in FIG. 9C. The dialer concatenates the Internal Dialing Protocol (IDP) and the domestic phone number. The IDP is a code dialed before a domestic phone number. The IDP for Great Britain is “0” and the domestic phone number is “2075811281” as indicated by the TIN-formatted phone number saved in the call log. After concatenation, the mobile device dials “02075811281” as shown in FIG. 8B.

FIG. 8C is another illustration of a screen of the mobile application showing a global dialer interface. FIG. 8C is explained in the context of FIGS. 1 to 8B. The global dialer interface may be used to manually dial both domestic and international phone numbers saved in the TIN format.

In an embodiment, a user may travel to Sao Paulo, Brazil and purchase a local SIM card. Brazil has multiple domestic carriers as shown in the database in FIG. 13. Each carrier has its own IDP (local trunk) and exit code. The user may select the local SIM card from the options displayed on the calling methods screen shown in FIG. 7A. The screen then displays a list of the domestic carriers in Brazil. The user may select the carrier Oi from the list. As shown in the database in FIG. 13, the local trunk for Oi is “031” and the exit code is “0031.” The user may decide to make a domestic phone call to a friend in Rio de Janeiro. The friend's phone number is “2198765432.” To place the phone call, the user may tap the dialer icon 814. Because the user's current location and the destination country are the same (Brazil), a local call logic sequence is initiated as illustrated in FIG. 9C. The dialer 814 concatenates the local trunk for the selected carrier Oi and the friend's phone number “2198765432.” The concatenated number “0312198765432” is dialed by the dialer 814 and saved in the call log as BRA.2198765432.

The user information label 802, city label 804, country selector 806, number display 808, dialing interface 810, GPS location selector 812, emergency numbers icon 816, and phone directory icon 818 are explained in the discussion of FIG. 8A.

FIG. 8D is an illustration of a screen of a mobile application showing the contacts list interface when an international phone call is made. FIG. 8D is explained in the context of FIGS. 1 to 8C.

In an embodiment, a user located in Brazil may want to call his or her contact Dr. Durpree in the United Kingdom. Dr. Durpree's phone number is saved in the contacts list in the TIN format GBR.7538705439. To place the phone call, the user taps Dr. Durpree's name in the contacts list. The application recognizes that the user is in Brazil and has selected Oi as the telecommunication carrier. The application also recognizes that the originating country Brazil is not the same as the United Kingdom (ISO code GBR), the call destination. As a result, the database for countries with multiple carriers is accessed and the exit code for the Brazilian carrier Oi is determined to be “0031.” Further, the dialing codes database is accessed and the entry code for the United Kingdom is determined to be “44.” Therefore, the External Dialing Protocol (EDP) for the call from Brazil (Oi) to the United Kingdom is “003144.” The EDP is the concatenation of the exit code for the selected carrier in the originating country and the entry code for the destination country.

The application may access the verification database and compare the first few digits of Dr. Durpree's phone number to the verification sequences for the United Kingdom. If a match is found, the mobile device dials “0031447538705439” as shown in FIG. 8D and the phone number is saved in the call log in the TIN format GBR.7538705439.

FIG. 8E is an illustration of a screen of a mobile application showing the dialer interface when an international phone call is made. FIG. 8E is explained in the context of FIGS. 1 to 8D.

In an embodiment, an international phone call may be made from Singapore to Malaysia. A user located in Singapore may select an international calling plan as the calling method before placing a call to a friend in Malaysia. The friend's phone number is “356987459.” The GPS or manual selection may be used to establish the user's current location. The user may change the country selector 806 to MYS, the ISO code for the destination country of Malaysia. The user's current location is not the same as the destination country. Therefore, the application may retrieve the exit code for Singapore and the entry code for Malaysia from the dialing codes database. The retrieved exit code is “000” and the entry code is “60.” The first few digits of the phone number match a verification sequence for Malaysia in the verification database. The application concatenates the exit code, entry code, and the phone number and the mobile device dials “00060356987459” as shown in FIG. 8E. The phone number is saved in the call log in the TIN format MYS.356987459.

The user information label 802, city label 804, number display 808, dialing interface 810, GPS location selector 812, dialer 814, emergency numbers icon 816, and phone directory icon 818 are explained in the discussion of FIG. 8A.

FIG. 9A is a process flow diagram of a method for dialing a phone number in the TIN format. FIG. 9A is explained in the context of FIGS. 1 to 8E. The process starts at block 900.

At block 900, the phone number USA.5011234567 is in the TIN format. “USA” is the ISO code for the United States and “5011234567” is a ten-digit US phone number. The process begins with the query at block 902.

At block 902, it is determined whether the ISO code in a TIN-formatted phone number may be the same as the ISO code for the user's current location. If the ISO codes are the same, the process continues at block 904. At block 904, the application initiates domestic call logic. The process continues at block 906. At block 906, the mobile device dials the concatenation of the IDP (if any) and the domestic phone number. Blocks 904 and 906 are explained in detail in FIGS. 9B and 9BB. The dialed phone number is saved to the call log in the TIN format and the process ends.

In an embodiment, a user may be located in the United States and wants to dial the TIN-formatted phone number USA.5011234567 shown above. The ISO code in the TIN-formatted phone number is the same as the ISO code for the user's current location. As such, the dialer initiates domestic call logic. However, concatenation is not needed because there is no IDP for mobile phone calls made in the United States. The number “5011234567” is dialed as is and saved to the call log as USA.5011234567. The process ends once the TIN-formatted phone number is saved.

If the ISO codes are not the same at block 902, the process may continue at block 908. At block 908, the application initiates international call logic. The process continues at block 910. At block 910, the mobile device dials the concatenation of the EDP and the international phone number. Blocks 908 and 910 are explained in detail in FIGS. 9D and 9DD. The dialed phone number is saved to the call log in the TIN format and the process ends.

FIGS. 9B and 9BB are a process flow diagram of a method for placing domestic phone calls. In particular, FIGS. 9B and 9BB illustrate domestic call logic. FIGS. 9B and 9BB are explained in the context of FIGS. 1 to 9A.

The user selects the ISO code for the destination country and the phone number to be dialed. The ISO code for the destination country matches the ISO code for the user's current location. Because the ISO codes are the same, the user will be placing a domestic phone call. Accordingly, the application initiates the domestic call logic sequence. The sequence begins with the user query at block 912.

At block 912, it is determined whether the country may use domestic carrier codes. (Recall that some countries have multiple telecommunication carriers and use different codes for different carriers. See FIG. 13.) If the country uses domestic carrier codes, the process continues with the query at block 914.

At block 914, it is determined whether the user may have previously saved a carrier as his or her default carrier. If the user has a default carrier, the process continues with the query at block 918. If the user does not have a default carrier, the process continues at block 916. At block 916, the user selects a carrier and saves it as his or her default carrier. The process continues with the query at block 918.

At block 918, it is determined whether the carrier may utilize different logic for intra-city and inter-city phone calls. In an embodiment, a user in Buenos Aires, Argentina selects the local SIM card option from the calling methods screen shown in FIG. 7A. Phone calls made to contacts in Buenos Aires are referred to as intra-city phone calls. Phone calls made to contacts in other cities in Argentina are referred to as inter-city phone calls. Some carriers use different logic for intra-city and inter-city phone calls.

At block 918, if it is determined that different logic may be used depending upon the destination city, the domestic call logic sequence continues with the query at block 920. At block 920, it is determined whether the phone call is an intra-city call. If the phone call is an intra-city call, the domestic call logic sequence continues at block 922. At block 922, the carrier's intra-city code is extracted from a database stored on the mobile device. The domestic call logic sequence continues at block 926.

At block 920, if it is determined that the phone call may not be an intra-city call (i.e., the phone call is an inter-city call), the domestic call logic sequence continues at block 924. At block 924, the carrier's inter-city code is extracted from the database stored on the mobile device. All inter-city phone calls are referred to as domestic long-distance calls. The domestic call logic sequence continues at block 926.

At block 926, the carrier's intra-city code extracted from the database at block 922 is captured by the domestic call logic. Alternatively, the carrier's inter-city code extracted from the database at block 924 is captured. Once a carrier code (either intra-city or inter-city) is captured, the domestic call logic sequence continues at block 948.

At block 912, if it is determined that the country does not use domestic carrier codes, the domestic call logic sequence continues with the query at block 934. At block 934, it is determined whether the country may use trunk prefixes. If trunk prefixes are used, the domestic call logic sequence continues with the query at block 936.

At block 936, it is determined whether the country's trunk prefixes may be different when dialing mobile devices or land lines. In an embodiment, a user may travel to Argentina where he or she selects the local SIM card option from the calling methods screen (FIG. 7A). In Argentina, the trunk prefixes are the same whether inter-city calls are made using a mobile device or a land line. However, the trunk prefixes for intra-city mobile devices and land lines are different. Thus, when the user places an intra-city call in Argentina, an alert appears on the screen of the mobile device. The alert reads “Argentina has different rules for land and mobile numbers. Please select the phone type.”

At block 936, if it is determined that the country uses different trunk prefixes for mobile devices and land lines, the domestic call logic sequence continues at block 942. At block 942, the domestic call logic captures the trunk prefix for mobile lines and the trunk prefix for land lines from a database stored on the mobile device. The domestic call logic then selects the appropriate trunk prefix. Once a trunk prefix (for either mobile devices or land lines) has been selected, the domestic call logic sequence continues at block 948.

At block 936, if it is determined that the country does not use different trunk prefixes for mobile devices and land lines, the domestic call logic sequence continues with the query at block 940. At block 940, it is determined whether a single digit will be used as a trunk-await tone before the selected dialing method is implemented. If a single-digit tone is to be used, the domestic call logic sequence continues at block 944.

At block 944, the single digit to be used as the trunk-await tone is captured from the dialing codes database shown in FIGS. 12A and 12B. The domestic call logic sequence programs the captured digit to pulse for five seconds when the user dials a phone number. For example, Belarus uses the digit “8” as the trunk-await tone for domestic phone calls. In an embodiment, a user located in Belarus may decide to call the domestic phone number “256398752.” The domestic call logic concatenates the digit “8” (the trunk-await tone) with the domestic phone number and programs the digit “8” to pulse for five seconds when the number “8256398752” is subsequently dialed. After the single digit has been programmed to pulse for five seconds, the domestic call logic sequence continues at block 948.

At block 940, if it is determined that a single digit may not be used as the trunk-await tome, the domestic call logic sequence continues at block 946. At block 946, the country's trunk prefix is captured from the dialing codes database shown in FIGS. 12A and 12B. The trunk prefix (IDP) is concatenated with the domestic phone number. Once concatenation has occurred, the domestic call logic sequence continues at block 948.

Trunk prefixes are used by more than 100 countries. The most common trunk prefixes are “1” for countries subscribing to the North American Numbering Plan (NANP), “8” for countries of the former Soviet Republic, and “0” for the majority of European, African; Asian; Pacific, and Middle Eastern countries. In these countries, the trunk prefix is concatenated with the domestic phone number when placing domestic calls.

At block 934, if it is determined that the country may not use trunk prefixes, the domestic call logic sequence continues at block 938. At block 938, no trunk prefix is captured from the dialing codes database shown in FIGS. 12A and 12B. The domestic call logic cannot capture a trunk prefix because the country does not use trunk prefixes. The domestic call logic sequence continues at block 948.

At block 948, the user may dial the domestic number. The domestic call logic sequence continues with the query at block 950.

At block 950, it is determined whether the dialed phone number passes a verification test. The verification test involves comparing the first few digits of the dialed phone number to verification sequences for the current country found in the verification database shown in FIG. 11. The verification test is explained in detail in FIG. 9C.

If the first few digits of the dialed phone number match a verification sequence, the phone number passes the verification test and the domestic call logic sequence continues at block 952. If the first few digits of the dialed phone number do not match a verification sequence, the phone number does not pass the verification test and the logic sequence continues at block 954 where the dialer resets.

At block 952, the destination city for the dialed phone number may be displayed in the city label 804 shown in FIG. 8A. The domestic call logic sequence continues with the query at block 956.

At block 956, it is determined whether the dialed phone number may conform to the MMR for the current country. The number of digits in the dialed phone number is compared to the minimum and maximum number of digits allowed in the country's phone numbers. The dialed phone number conforms to the MMR if the number of digits in the phone number falls within the range defined by the minimum and maximum number of allowable digits. The dialed phone number does not conform to the MMR if the number of digits in the phone number does not fall within the specified range. If the dialed phone number conforms to the MMR, the domestic call logic sequence continues at block 958. If the dialed phone number does not conform to the MMR, the domestic call logic sequence continues at block 954 where the dialer resets.

At block 958, the dialer concatenates the captured code or captured prefix and the dialed phone number. The captured code may be a carrier code, intra-city code, or inter-city code. The captured prefix may be a trunk prefix, mobile-device prefix, or land-line prefix. Once concatenation has occurred, the domestic call logic sequence continues at block 960. At block 960, the concatenated number is saved to the call log and the domestic call logic sequence ends.

FIG. 9C is a process flow diagram of a method for verifying phone numbers. FIG. 9C is explained in the context of FIGS. 1 to 9B. The phone number verification process begins when a user starts dialing a phone number and continues with the query at block 964.

At block 964, it is determined whether the sixth digit of the phone number may have been entered. Using the dialing pad 810 shown in FIG. 8A, the user enters the digits of the phone number. When the sixth digit has been entered, the verification process continues with the query at block 962. If the sixth digit has not been entered, the user continues to dial at block 966. The user adds digits to the phone number until the sixth digit has been entered and the verification process can progress from block 964 to block 962.

At block 962, it is determined whether the user may be placing a domestic phone call. If the user is making a domestic call, the verification process continues at block 968. At block 968, the entry code for the current country is captured from the dialing codes database shown in FIGS. 12A and 12B. The verification process concatenates the entry code and the first six dialed digits. After concatenation, the verification process continues with the query at block 972.

At block 972, it is determined whether the domestic phone call may be toll-free. If the phone call is toll-free, the verification process continues at block 980. At block 980, the search predicate is modified to restrict the search of the verification database (FIG. 11) to verification codes for toll-free calls. Once the search predicate has been changed, the verification process continues at block 974. At block 972, if it is determined that the domestic phone call is not toll-free, the verification process continues at block 974.

At block 962, if it is determined that the user is not making a domestic phone call, the verification process continues at block 970. At block 970, the entry code for the destination country is captured from the dialing codes database shown in FIGS. 12A and 12B. After capture of the entry code, the verification process continues at block 974.

At block 974, the verification process may concatenate the captured code and the first six dialed digits to form a verification string. The captured code may be the entry code for the current country (block 968), the verification code for a toll-free domestic call (block 980), or the entry code for the destination country (block 970). After concatenation, the verification process continues at block 976. At block 976, a loop counter is set to 1 before the loop begins at block 978.

At block 978, the verification process may search for a verification sequence in the verification database (FIG. 11) that matches the verification string (concatenation of the captured code and the first six dialed digits). The verification process continues with the query at block 982. At block 982, it is determined whether a matching verification sequence is found. If there is a match, the verification process continues at block 984.

At block 984, the city label 804 in FIG. 8A may be updated with the verification sequence's associated city. Once the city label 804 is updated, the verification process continues at block 994, where the user continues dialing.

At block 982, if it is determined that a matching verification sequence may not be found, the verification process continues with the query at block 990. At block 990, it is determined whether the loop counter is equal to 6. If the loop counter equals 6, the verification process continues at block 992. At block 992, the global dialer interface shown in FIG. 8A displays an alert that reads “Does not match verification process.” Once the alert is displayed, the verification process continues with the query at block 996.

At block 996, it is determined whether the user may elect to continue. If the user elects to continue, the verification process continues at block 994, where the user continues dialing. If the user does not elect to continue, the verification process continues at block 998, where the dialer resets.

At block 990, if the loop counter does not equal 6, the verification process may continue at block 988. At block 988, the number of digits in the verification string is reduced by the value of the loop counter. Once the length of the verification string has been shortened, the verification process continues at block 986, where the loop counter is updated (i.e., the value of the loop counter is increased by one). Once the loop counter is updated, the verification process continues at block 978.

At block 978, the verification process may search for a verification sequence in the verification database (FIG. 11) that matches the remaining digits of the verification string. The loop made up of blocks 978, 982, 990, 988, and 986 iterates until the loop counter is equal to 6 at block 990. Once the loop counter equals 6, the verification process continues at block 992.

At block 992, the global dialer interface shown in FIG. 8A may display an alert that reads “Does not match verification process.” Once the alert is displayed, the verification process continues with the query at block 996.

At block 996, it is determined whether the user may elect to continue. If the user elects to continue, the verification process continues at block 994, where the user continues dialing. If the user does not elect to continue, the verification process continues at block 998, where the dialer resets.

FIGS. 9D and 9DD are a process flow diagram of a method for placing international phone calls. FIGS. 9D and 9DD are explained in the context of FIGS. 1 to 9C. A user may select the destination country and the number to be dialed. The process begins at block 1000. At block 1000, the country associated with the ISO code in the TIN-formatted phone number does not match the country where the user is currently located. The process continues at block 1002, where the international call logic sequence is invoked. The logic sequence begins with the query at block 1008.

At block 1008, it is determined whether the current country and the destination country may be members of the same telecommunication alliance. There are a number of alliances. For example, the North American Numbering Plan (NANP) is an alliance encompassing the US territories and countries located primarily in North America and the Caribbean. The East African Telephone Numbering Plan includes Tanzania, Uganda and Kenya.

At block 1008, if the countries are members of the same alliance, the international call logic sequence may continue at block 1010. At block 1010, alliance logic is used to capture the EDP for the international phone number. The use of alliance logic is explained in detail in FIG. 9E. The international call logic sequence continues at block 1028.

At block 1008, if the current country and the destination country are not members of the same telecommunication alliance, the international call logic sequence may continue with the query at block 1012. At block 1012, it is determined whether the current country uses international carrier codes. If the current country uses international carrier codes, the international call logic sequence continues at block 1014.

At block 1014, the appropriate international carrier code may be captured from the database shown in FIG. 13. The international call logic sequence continues with the query at block 1022.

At block 1012, if it is determined that the current country does not use international carrier codes, the international call logic sequence may continue with the query at block 1016. At block 1016, it is determined whether the current country uses an exit code with a digit await-tone that precedes the dialing method. If the current country uses an await-tone, the international call logic sequence continues at block 1018.

At block 1018, the single-digit await code and the current country's exit code may be captured. The single-digit await code is programmed to pulse for five seconds before the exit code is dialed. For example, an await-tone is used in Belarus, Kazakhstan, Tajikistan, and Turkmenistan. If a user makes an international call from Belarus to a phone number in the United States, the phone number must be preceded by “8101,” where “8” is the await-tone, “10” is the exit code for Belarus, and “1” is the entry code for the United States. The single digit “8” pulses for five seconds before “101” and the phone number can be dialed. After the codes are captured, the international call logic sequence continues with the query at block 1022.

At block 1016, if the current country does not use an await-tone, the international call logic sequence may continue at block 1020. At block 1020, the current country's exit code is captured from the dialing codes database shown in FIGS. 12A and 12B. After the capture of the exit code, the international call logic sequence continues with the query at block 1022.

At block 1022, it is determined whether the destination county may use different entry codes for mobile devices and land lines. If different entry codes are used, the international call logic sequence continues at block 1024.

At block 1024, the destination country's entry codes for mobile devices and land lines may be determined. The current country's EDP is concatenated with the destination country's entry code and the destination country's entry code for mobile devices or the entry code for land lines. After concatenation occurs, the international call logic sequence continues at block 1028.

At block 1022, if it is determined that the destination country does not use different entry codes for mobile devices and land lines, the international call logic sequence continues at block 1026. At block 1026, the current country's EDP and the destination country's entry code are concatenated. After concatenation occurs, the international call logic sequence continues at block 1028.

At block 1028, the user may dial the phone number from block 1010, block 1024, or block 1026. Once the phone number has been dialed, the international call logic sequence continues with the query at block 1030.

At block 1030, it is determined whether the dialed phone number may pass a verification test. The verification test involves comparing the first few digits of the dialed phone number to verification sequences for the destination country found in the verification database shown in FIG. 11. The verification test is explained in detail in FIG. 9C.

If the first few digits of the dialed phone number match a verification sequence, the phone number passes the verification test and the international call logic sequence may continue at block 1036. At block 1036, the destination city for the dialed phone number is displayed in the city label 804 shown in FIG. 8A. The international call logic sequence continues with the query at block 1032.

If the first few digits of the dialed phone number do not match a verification sequence, the phone number does not pass the verification test and the logic sequence may continue at block 1034, where the dialer resets. After the dialer resets, the international call logic sequence continues at block 1028. At block 1028, the user dials the phone number again in case the phone number was incorrectly dialed before. The international call logic sequence continues with a repeat of the query at block 1030.

At block 1032, it is determined whether the dialed phone number may conform to the MMR for the destination country. The number of digits in the dialed phone number is compared to the minimum and maximum number of digits allowed in the destination country's phone numbers. The dialed phone number conforms to the MMR if the number of digits in the phone number falls within the range defined by the minimum and maximum number of allowable digits. The dialed phone number does not conform to the MMR if the number of digits in the phone number does not fall within the specified range. If the dialed phone number conforms to the MMR, the international call logic sequence continues at block 1038. If the dialed phone number does not conform to the MMR, the international call logic sequence continues at block 1034, where the dialer resets.

At block 1038, the dialer may concatenate the EDP and the dialed phone number. Once concatenation has occurred, the international call logic sequence continues at block 1040. At block 1040, the concatenated number is saved to the call log and the international call logic sequence ends.

FIG. 9E is a process flow diagram of a method for placing phone calls within an international telecommunication alliance. FIG. 9E is explained in the context of FIGS. 1 to 9DD. The process begins at block 1050.

At block 1050, a common alliance may be found by accessing the dialing codes database shown in FIGS. 12A and 12B and comparing records for the originating and destination countries. A match is found if the records for both the originating and destination countries contain a reference to the same alliance. The process continues at block 1052. At block 1052, the alliance dialing code is captured from the destination country record. The process continues at block 1054.

At block 1054, the user may dial the destination phone number. Once the phone number has been dialed, the process continues with the query at block 1056. At block 1056, it is determined whether the dialed phone number passes a verification test. The verification test involves comparing the first few digits of the dialed phone number to verification sequences for the destination country found in the verification database shown in FIG. 11. The verification test is explained in detail in FIG. 9C.

If the first few digits of the dialed phone number match a verification sequence, the phone number passes the verification test and the process may continue at block 1058. At block 1058, the destination city for the dialed phone number is displayed in the city label 804 shown in FIG. 8A. The process continues with the query at block 1062.

At block 1056, if the first few digits of the dialed phone number do not match a verification sequence, the phone number does not pass the verification test and the process continues at block 1060, where the dialer resets. After the dialer resets, the process continues at block 1054. At block 1054, the user dials the phone number again in case the phone number was incorrectly dialed before. The process continues with a repeat of the query at block 1056.

At block 1062, it is determined whether the dialed phone number conforms to the MMR for the destination country. The number of digits in the dialed phone number may be compared to the minimum and maximum number of digits allowed in the destination country's phone numbers. The dialed phone number conforms to the MMR if the number of digits in the phone number falls within the range defined by the minimum and maximum number of allowable digits. The dialed phone number does not conform to the MMR if the number of digits in the phone number does not fall within the specified range. If the dialed phone number conforms to the MMR, the process continues at block 1064. If the dialed phone number does not conform to the MMR, the process continues at block 1060, where the dialer resets.

At block 1064, the dialer may concatenate the alliance code and the dialed phone number. Once concatenation has occurred, the process continues at block 1066. At block 1066, the concatenated number is saved to the call log and the process ends.

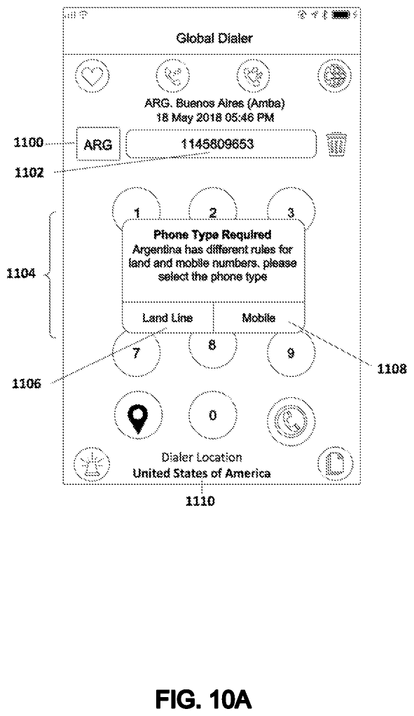

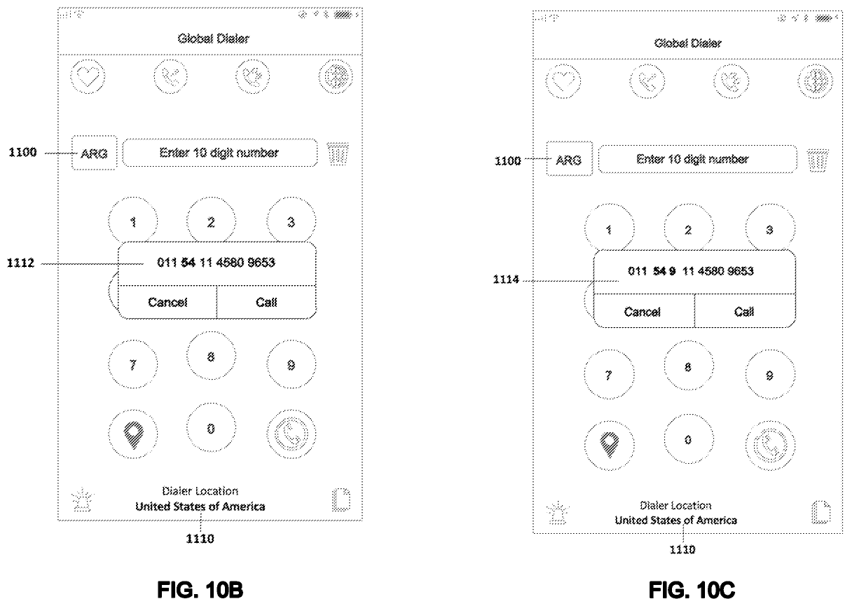

FIG. 10A is an illustration of a screen of the mobile application for placing international phone calls. FIG. 10A is explained in the context of FIGS. 1 to FIG. 9E. In FIG. 10A, an international phone call is being placed to Argentina from the United States. The ISO code for the destination country 1100 is ARG for Argentina. The phone number to be dialed is shown in the number display 1102. The current dialing location 1110 indicates that the United States is the originating country.

Argentina has different prefixes for land lines and mobile devices. This type of prefix may be missing from the phone number shown in the number display 1102. Therefore, a country number query 1104 appears on the screen. The query 1104 reads “Argentina has different rules for land and mobile numbers. Please select the phone type.” In an embodiment, the user may be placing a phone call to a land line. The user selects the option “Land Line” 1106 which requires the addition of a land-line entry prefix to the phone number. In another embodiment, the user may be placing a phone call to a mobile device. The user selects the option “Mobile” 1108 which requires the addition of a mobile entry prefix to the phone number. The entry prefix (land line or mobile) is inserted after the country code and before the phone number as will be seen in FIGS. 10B and 10C.

FIG. 10B is an illustration of a screen of the mobile application for placing an international phone call to a land line in Argentina. FIG. 10B is explained in the context of FIGS. 1 to 10A. As in FIG. 10A, the ISO code for the destination country 1100 is ARG for Argentina and the current dialing location 1110 indicates that the United States is the originating country. The screen in FIG. 10B appears after the user selects the option “Land Line” from the screen shown in FIG. 10A. In FIG. 10B, the phone number 1112 includes the land-line entry code “54.” The phone number may be saved to memory as ARG.1145809653. The phone type (land line) is also saved to memory.

FIG. 10C is an illustration of a screen of the mobile application for placing an international phone call to a mobile device in Argentina. FIG. 10C is explained in the context of FIGS. 1 to 10B. As in FIG. 10A, the ISO code for the destination country 1100 is ARG for Argentina and the current dialing location 1110 indicates that the United States is the originating country. The screen in FIG. 10C appears after the user selects the option “Mobile” from the screen shown in FIG. 10A. In FIG. 10C, the phone number 1114 includes the mobile entry code “549.” The phone number may be saved to memory as ARG.1145809653. The phone type (mobile) is also saved to memory.

It should be understood that each block of the various process flow diagrams described herein may be implemented by hardware, firmware, processor, circuitry, or other communication device capable of executing software. For example, one or more of the methods described above may be embodied by computer programs. As will be appreciated, any such program may be loaded onto a computer or other programmable apparatus (e.g., hardware) to produce a machine, such that the resulting computer or other programmable apparatus implements the functions specified in the blocks of the process flow diagrams. These computer programs may also be stored in a computer-readable memory that may direct a computer or other programmable apparatus to function in a particular manner, such that the instructions stored in the computer-readable memory produce an article of manufacture which implements the functions specified in the flow diagram blocks. The computer program may also be loaded onto a computer or other programmable apparatus to cause a series of operations to be performed on the computer or other programmable apparatus to produce a computer-implemented process, such that the instructions which execute on the computer or other programmable apparatus provide operations for implementing the functions specified in the flow diagram blocks.

Accordingly, the blocks of the process flow diagrams may involve combinations of means for performing the specified functions and combinations of operations for performing such specified functions. It should also be understood that one or more blocks of the process flow diagrams, and combinations of blocks, may be implemented by special purpose hardware-based computer systems or combinations of special purpose hardware and computer programs.

At least some of the steps, functions, or procedures described herein are implemented via a computer program loaded into a memory for execution by processing circuitry including one or more processors. The processor(s) and memory are interconnected to enable normal software execution. An optional input/output device may also be interconnected to the processor(s) or the memory to enable input or output of relevant data such as input parameter(s) or resulting output parameter(s). The term “processor” should be interpreted in a general sense as any system or device capable of executing program code to perform a particular processing, determining, or computing task. The processing circuitry is thus configured to perform well-defined processing tasks such as those described herein. The processing circuitry does not have to be dedicated exclusively to performing the above-described steps, functions, procedures, or blocks, but may execute other tasks as well.

Moreover, the software application described herein may be embodied entirely on any form of computer-readable storage medium having stored thereon an appropriate set of instructions for use by an instruction-execution system, apparatus, or device, such as a computer-based system, processor-containing system, or other system that can retrieve instructions from a storage medium and execute the instructions.

The software may be a computer program which is normally stored on a non-transitory computer-readable medium, such as a CD, DVD, USB memory device, hard drive, or any other conventional memory device. The software may thus be loaded into the operating memory of a computer or equivalent processing system for execution by a processor. The computer/processor does not have to be dedicated exclusively to performing the above-described steps, functions, procedures, or blocks, but may execute other software tasks as well.

The process flow diagrams presented herein may be regarded as computer flow diagrams when performed by one or more processors. A corresponding apparatus may be defined as a group of function modules, where each step performed by the processor corresponds to a function module. In this case, the function modules are implemented as a computer program running on the processor.

The computer program residing in memory may thus be organized as appropriate function modules configured to perform at least part of the steps or tasks described herein. Alternatively, it is possible that the modules may be predominantly hardware modules with suitable interconnections. Particular examples include suitably configured digital signal processors and other known electronic circuits (e.g., Application Specific Integrated Circuits (ASICs) or discrete logic gates interconnected to perform a specialized function). Other examples of hardware that may be used include input/output (I/O) circuitry or circuitry for receiving or sending signals. The amount of software versus hardware utilized is purely an implementation decision.

It is becoming increasingly commonplace to provide computing capabilities (hardware or software) where the resources are delivered as a service to remote locations via a network. By way of example, this means that functionality, as described herein, can be distributed or relocated to one or more separate physical nodes or servers. The functionality may be relocated or distributed to one or more jointly acting physical or virtual machines that can be positioned in separate physical node(s) (i.e., in the cloud). This is sometimes referred to as cloud computing, which enables on-demand network access to a pool of configurable computing resources, such as networks, servers, storage, applications, and general or customized services.

The embodiments described herein are a few illustrative examples of the present techniques. It should be understood by those skilled in the art that various modifications, combinations, and changes may be made to these embodiments without departing from the scope of the present techniques. In particular, components of the different embodiments can be combined in other configurations if technically feasible.

It should be understood that the methods described herein may be combined and rearranged in a variety of ways. The methods may be performed by one or more suitably programmed or configured digital signal processors and other known electronic circuitry (e.g. discrete logic gates interconnected to perform a specialized function or application-specific integrated circuits). For example, many aspects of the techniques disclosed herein are described as sequences of actions that can be performed by components of a programmable computer system. The steps, functions, procedures, or blocks described above may be implemented using conventional hardware, such as discrete circuit or integrated circuit technology, including both general-purpose electronic circuitry and application-specific circuitry.

Alternatively, at least some of the steps, functions, procedures, or blocks described above may be implemented in software for execution by a suitable computing device or processing device, such as a microprocessor, Digital Signal Processor (DSP), or any suitable programmable logic device such as a Field Programmable Gate Array (FPGA).

It should also be understood that the general processing capabilities of any device implementing the present techniques may be reused. The reuse of software may be accomplished by reprogramming the existing software or by adding new software components to the existing software. Solutions based on a combination of hardware and software are possible. The actual combination (i.e., amount of hardware versus software) may be decided by a system designer. When determining the partition between hardware and software, the system designer may consider a number of factors, such as processing speed, cost of implementation, and other system requirements.

Other embodiments of the techniques disclosed herein will be apparent to those skilled in the art having the benefit of this disclosure. Therefore, the techniques described above are not limited to the specific embodiments disclosed and modifications and other embodiments are within the scope of the appended claims. Although the present disclosure describes example embodiments in the context of certain combinations of elements or functions, it should be appreciated that different combinations of elements or functions may be included in alternative embodiments without departing from the scope of the appended claims. In other words, combinations of elements or functions differing from those explicitly described above are within the scope of the appended claims. Further, specific terms are employed herein, but they are used in a descriptive sense only and not for purposes of limitation.

What is claimed is:

1. A method for using a global dialing format, comprising:
displaying a sequence of digits to be dialed from a communication device;
determining a current country for the communication device;
determining a destination country for the sequence of digits;
accessing a database to obtain an exit code for the current country and a standardized country code for the destination country, wherein the standardized country code corresponds to an entry code for the destination country;
converting the sequence of digits to a phone number in the global dialing format, wherein the phone number comprises the exit code for the current country, the standardized country code for the destination country, and the sequence of digits; and
dialing the phone number.

2. The method of claim 1, wherein the database is stored on the communication device.

3. The method of claim 1, wherein determining a destination country for the sequence of digits comprises obtaining the destination country from a user interface on the communication device.

4. The method of claim 1, further comprising:
obtaining a verification sequence from a verification database, wherein the verification sequence comprises a substring of digits from one or more phone numbers in the destination country;
comparing the verification sequence to the sequence of digits to be dialed; and
authenticating the sequence of digits by matching the verification sequence to a subset of digits from the sequence of digits.

5. The method of claim 1, further comprising:
determining a digit count for the sequence of digits to be dialed;
obtaining a minimum number of digits and a maximum number of digits in a phone number from the destination country;
formulating a range of permissible digits in a phone number from the destination country, wherein the minimum number of digits and the maximum number of digits comprise endpoints of the range;
comparing the digit count for the sequence of digits to be dialed to the range of permissible digits; and
authenticating the sequence of digits by matching the digit count of the sequence of digits with a number in the range of permissible digits in a phone number from the destination country.

6. The method of claim 1, further comprising adding the phone number in the global dialing format to a contacts list stored on the communication device.

7. The method of claim 1, wherein determining a current country for the communication device comprises obtaining data from a group consisting of a global positioning system on the communication device, a screen on the communication device for manual entry of the current country, and registration information including the current country stored on the communication device.

8. A method for converting a sequence of digits to a global dialing format, comprising:
obtaining a first standardized country code for a destination country of the sequence of digits, a verification sequence for the destination country, and a minimum and maximum rule (MMR) for the destination country;
comparing the sequence of digits to the verification sequence and the MMR;
determining the sequence of digits conforms to the verification sequence and the MMR;
formatting the sequence of digits to obtain a phone number in the global dialing format, wherein the phone number comprises the first standardized country code for the destination country and the sequence of digits; and
dialing the phone number in the global dialing format.

9. The method of claim 8, further comprising:
determining the sequence of digits conforms to the verification sequence and the MMR for two or more countries;
determining the destination country from a second standardized country code obtained from a user interface on a communication device; and
concatenating the second standardized country code and the sequence of digits.

10. The method of claim 8, wherein dialing the phone number in the global dialing format comprises placing an international phone call when the destination country associated with the first standardized country code in the phone number does not match a current country for the communication device.

11. The method of claim 10, wherein the current country is determined by receiving data from a group consisting of a global positioning system on the communication device, a screen on the communication device for manual entry of the current country, and registration information including the current country stored on the communication device.

12. The method of claim 8, wherein dialing the phone number in the global dialing format comprises placing a domestic phone call when the destination country associated with the first standardized country code in the phone number in the global dialing format matches the current country for the communication device.

13. At least one computer-readable medium, comprising instructions to direct at least one processor to:
display a sequence of digits to be dialed by a communication device;
determine a current country for the communication device;
determine a destination country for the sequence of digits;
access a database to obtain an exit code for the current country and a standardized country code for the destination country, wherein the standardized country code corresponds to an entry code for the destination country;
convert the sequence of digits to a phone number in a global dialing format, wherein the phone number in the global dialing format comprises the exit code for the current country, the standardized country code for the destination country, and the sequence of digits; and
dial the phone number in the global dialing format.

14. The at least one computer-readable medium of claim 13, comprising instructions to obtain data from a user interface on the communication device to determine the destination country.

15. The at least one computer-readable medium of claim 13, comprising instructions to:
obtain a verification sequence from a verification database, wherein the verification sequence comprises a substring of digits from one or more phone numbers in the destination country;
compare the verification sequence to the sequence of digits to be dialed; and
authenticate the sequence of digits by matching the verification sequence to a subset of digits from the sequence of digits.

16. The at least one computer-readable medium of claim 13, comprising instructions to:
determine a digit count for the sequence of digits to be dialed;
obtain a minimum number of digits and a maximum number of digits in a phone number from the destination country;
formulate a range of permissible digits in a phone number from the destination country, wherein the minimum number of digits and the maximum number of digits comprise endpoints of the range;
compare the digit count for the sequence of digits to the range of permissible digits in a phone number from the destination country; and
authenticate the sequence of digits by matching the digit count of the sequence of digits with a number in the range of permissible digits in a phone number from the destination country.

17. The at least one computer-readable medium of claim 13, comprising instructions to add the phone number in the global dialing format to a contacts list stored on the communication device.

18. The at least one computer-readable medium of claim 13, comprising instructions to determine the current country for the communication device by receiving data from a group consisting of a global positioning system on the communication device, a screen on the communication device for manual entry of the current country, and registration information including the current country stored on the communication device.

19. At least one computer-readable medium, comprising instructions to direct at least one processor to:
obtain a first standardized country code for a destination country of a sequence of digits, a verification sequence for the destination country, and a minimum and maximum rule (MMR) for the destination country;
compare the sequence of digits to the verification sequence and the MMR;
determine the sequence of digits conforms to the verification sequence and the MMR;
format the sequence of digits to obtain a phone number in the global dialing format, wherein the phone number comprises the first standardized country code for the destination country and the sequence of digits; and
dial the phone number in the global dialing format.

20. The at least one computer-readable medium of claim 19, comprising instructions to:
determine the sequence of digits conforms to the verification sequence and the MMR for two or more countries;
determine the destination country from a second standardized country code obtained from a user interface on a communication device; and
concatenate the second standardized country code and the sequence of digits.
